(19) United States
(12) Patent Application Publication
(10) Pub. No.: US 2024/0203020 A1
(43) Pub. Date: Jun. 20, 2024

(54) SYSTEMS AND METHODS FOR GENERATING OR RENDERING A THREE-DIMENSIONAL REPRESENTATION

(71) Applicant: Hover Inc., San Francisco, CA (US)

(72) Inventors: Matthew THOMAS, San Francisco, CA (US); Harsh BARBHAIYA, San Francisco, CA (US); Jeffrey SOMMERS, San Francisco, CA (US)

(73) Assignee: Hover Inc., San Francisco, CA (US)

(21) Appl. No.: 18/555,724

(22) PCT Filed: Apr. 12, 2022
(86) PCT No.: PCT/US2022/024401

§ 371 Date: Oct. 16, 2023

Related U.S. Application Data
(60) Provisional application No. 63/329,001, filed on Apr. 8, 2022.
(60) Provisional application No. 63/175,668, filed on Apr. 16, 2021.

(51) Int. Cl. G06T 15/00; G06T 7/174; G06T 7/73; G06T 11/00

(52) U.S. Cl. CPC G06T 15/00; G06T 7/174; G06T 7/74; G06T 11/00; G06T 2207/10028; G06T 2207/30244

(57) ABSTRACT

Systems and methods for generating or rendering a three-dimensional (3D) representation of a structure based on images of the structure are disclosed. A selectively rendered point cloud is generated based on the images of the structure and real cameras associated with a virtual camera observing the selectively rendered point cloud. Images attributes may be applied to the selectively rendered point cloud.

### CROSS-REFERENCE TO RELATED APPLICATIONS

The present application claims priority to U.S. Provisional Application No. 63/175,668 filed on Apr. 16, 2021 entitled “SYSTEMS AND METHODS FOR GENERATING OR RENDERING A THREE-DIMENSIONAL REPRESENTATION,” and U.S. Provisional Application No. 63/329,001 filed on Apr. 8, 2022 entitled “SYSTEMS AND METHODS FOR GENERATING OR RENDERING A THREE-DIMENSIONAL REPRESENTATION,” which are hereby incorporated by reference herein in their entirety.

### BACKGROUND

### Field of the Invention

This disclosure generally relates to generating or rendering a three-dimensional representation.

### Description of Related Art

Three-dimensional (3D) representations of a structure can be generated based on two-dimensional (2D) images taken of the structure. The images can be taken via aerial imagery, specialized-camera equipped vehicles, or by a user with a camera from a ground-level perspective such as a smartphone. The 3D representation is a representation of the physical, real-world structure.

It may be difficult to interpret a 3D representation including all points, or all line segments, especially if a pose of a virtual camera associated with a view of the 3D representation is not known to a viewer of the 3D representation. Interactions with the 3D representation from the virtual camera may act upon points, or line segments, due to apparent visual proximity from the pose of the virtual camera despite the points, or the line segments, having significant spatial differences for their real world-counterparts.

Generating or rendering 3D representations including all points from a point cloud, or all line segments from a line cloud, can be resource intensive and computationally expensive.

### BRIEF SUMMARY

Described herein are various methods for generating or rendering a three-dimensional (3D) representation. A point cloud represents aggregate data from input data (e.g., 2D images) and a 3D representation of the point cloud can include all or a subset of the points of the point cloud. Generating or rendering a 3D representation including all points of a point cloud can be considered “full rendering,” and generating or rendering a 3D representation including a subset of points of a point cloud, or modified points of a point cloud, from a perspective of a virtual camera can be considered “selective rendering.”

Full rendering can provide completeness for the 3D representation as collected from input data (e.g., images) by providing spatial accuracy for the aggregate positions of the points of the point cloud. Full rendering can result in a 3D representation that is not necessarily similar to what a physical (or real) camera would observe if a digital environment including the point cloud was a real environment, whereas selective rendering can result in a 3D representation that is similar to what a physical (or real) camera would observe if the digital environment including the point cloud was a real environment. In other words, selective rendering more accurately represents the points of the point cloud for the physical (or real) camera than full rendering.

Full rendering can be resource intensive, computationally expensive, and result in a 3D representation that may be difficult to interpret. When compared to full rendering, selective rendering can require fewer computing resources, require less complex processing algorithms, result in a data package that is easier to transfer, manage, and store, and result in a 3D representation that is easier to interpret.

Instead of directing computing resources to rendering all the points of the point cloud, as is the case with full rendering, computing resources can be directed to rendering a subset of points of the point cloud from the perspective of the virtual camera, based on the virtual camera's relationship to a subset of real cameras, based on the virtual camera's relationship to a subset of points of the point cloud, or a combination thereof. Such selective rendering can result in a more efficient use of the computing resources. Examples of resources that are used in rendering include, for example, central processing units (CPUs), graphics processing units (GPUs), power, time, and storage. For example, when compared to full rendering, selective rendering may be performed using less power, in less time, more efficiently, and the like. Full rendering may require the use of advanced render protocols, whereas selective rendering may obviate the need for advanced render protocols due to the difference in the number of points being rendered.

In some embodiments, a method for generating a three-dimensional (3D) representation includes receiving a plurality of images associated with a plurality of real cameras, generating a point cloud based on the plurality of images, wherein the point cloud comprises a plurality of points, selecting real cameras associated with a virtual camera, wherein the selected real cameras comprise a subset of the plurality of real cameras, and generating a 3D representation comprising a subset of the plurality of points of the point cloud from a perspective of the virtual camera based on a relation of the virtual camera to the selected real cameras.

In some embodiments, a method for generating a three-dimensional (3D) representation includes receiving a plurality of images associated with a plurality of real cameras, generating a point cloud based on the plurality of images, wherein the point cloud comprises a plurality of points, selecting points of the point cloud associated with a virtual camera, wherein the selected points comprise a subset of the plurality of points, and generating a 3D representation comprising the selected points from a perspective of the virtual camera based on a relation of the virtual camera to the selected points.

In some embodiments, a method for generating a three-dimensional (3D) representation including receiving a plurality of images associated with a plurality of real cameras, generating a point cloud based on the plurality of images, wherein the point cloud comprises a plurality of points, calculating distances between the plurality of real cameras and a virtual camera, and generating a three-dimensional (3D) representation comprising a subset of the plurality of points of the point cloud from a perspective of the virtual camera based on the distances between the plurality of real cameras and the virtual camera.

In some embodiments, a method for rendering points including receiving a plurality of images associated with a plurality of real cameras, generating a point cloud based on the plurality of images, wherein the point cloud comprises a plurality of points, selecting first real cameras associated with a first virtual camera, wherein the first real cameras comprise a first subset of the plurality of real cameras, selecting second real cameras associated with a second virtual camera, wherein the second real cameras comprise a second subset of the plurality of real cameras, selecting a first plurality of points of the point cloud based on a first relation of the first virtual camera to the first real cameras, selecting a second plurality of points of the point cloud based on a second relation of the second virtual camera to the second real cameras, and rendering the first plurality of points and the second plurality of points based on a transition from the first virtual camera to the second virtual camera.

In some embodiments, a method for generating a path of a virtual camera includes receiving one or more images, for each image of the one or more of images, calculating a pose of a real camera associated with the image, and generating a path of a virtual camera based on the calculated poses of the real cameras.

These are other embodiments, and the benefits they provide, are described more fully with reference to the drawings and detailed description.

### BRIEF DESCRIPTION OF THE DRAWINGS

Figure (FIG. 1 illustrates a flow diagram for generating or rendering a three-dimensional (3D) representation, according to some embodiments.

FIG. 2A illustrates a ground-level image capture, according to some embodiments.

FIG. 2B illustrates a point cloud of a ground-level image capture, according to some embodiments.

FIG. 2C illustrates a line cloud of a ground-level image capture, according to some embodiments.

FIGS. 3A-3C illustrate 2D representations, according to some embodiments.

FIGS. 4A-4C illustrate 3D representations, according to some embodiments.

FIG. 5 illustrates a flow diagram for generating or rendering a 3D representation, according to some embodiments.

FIG. 6A illustrates a ground-level image capture, according to some embodiments.

FIG. 6B illustrates a point cloud of a ground-level capture, according to some embodiments.

FIG. 6C illustrates a modified point cloud, according to some embodiments.

FIG. 6D illustrates a line cloud of a ground-level capture, according to some embodiments.

FIG. 6E illustrates a modified line cloud, according to some embodiments.

FIGS. 7A-7D illustrate experimental results of selective point cloud or line cloud renderings of 3D representations, according to some embodiments.

FIG. 8 illustrates a flow diagram for generating or rendering a 3D representation, according to some embodiments.

FIG. 9A illustrates a ground-level image capture, according to some embodiments.

FIG. 9B illustrates a point cloud of a ground-level capture, according to some embodiments.

FIG. 9C illustrates a modified point cloud, according to some embodiments.

FIG. 9D illustrates a line cloud of a ground-level capture, according to some embodiments.

FIG. 9E illustrates a modified line cloud, according to some embodiments.

FIGS. 10A-10D illustrate experimental results of modified point cloud or line cloud renderings of 3D representations, according to some embodiments.

FIG. 11 illustrates a flow diagram for rendering points based on a transition from a first virtual camera pose to a second virtual camera pose, according to some embodiments.

FIG. 12 illustrates a ground-level image capture and transitioning virtual cameras, according to some embodiments.

FIG. 13 illustrates a flow diagram for generating a path of a virtual camera, according to some embodiments.

FIG. 14 illustrates a capture of two adjacent rooms, according to some embodiments.

FIG. 15 illustrates a block diagram of a computer system that may be used to implement the techniques described herein, according to some embodiments.

In the following description, for the purposes of explanation, numerous specific details are set forth in order to provide a thorough understanding of the present disclosure. It will be appreciated, however, that the present disclosure may be practiced without these specific details. In other instances, well-known structures and devices are shown in block diagram form in order to avoid unnecessarily obscuring the present disclosure. Like reference numbers and designations in the various drawing indicate like elements.

### DETAILED DESCRIPTION

Figure (FIG. 1 illustrates a method 100 for generating or rendering a three-dimensional (3D) representation, according to some embodiments. At step 102, images are received. A data capture device, such as a smartphone or a tablet computer, can capture the images. Other examples of data capture devices include drones and aircraft. The images can include image data (e.g., color information) and/or depth data (e.g., depth information). The image data can be from an image sensor, such as a charge coupled device (CCD) sensor or a complementary metal-oxide-semiconductor (CMOS) sensor, embedded within the data capture device. The depth data can be from a depth sensor, such as a LiDAR sensor or a time-of-flight sensor, embedded within the data capture device.

At step 104, a point cloud is generated based on the received images. A point cloud is a set of data points in a 3D coordinate system. The point cloud can represent co-visible points across the images. Generating the point cloud based on the received images can include implementing one or more techniques, such as, for example, a structure-from-motion (SfM) technique which utilizes two-dimensional (2D) images (i.e., the image data of the images) to construct a 3D structure (i.e., the point cloud). In some embodiments, the point cloud is a line cloud. A line cloud is a set of data line segments in a 3D coordinate system. The line cloud can represent co-visible line segments across the images. Generating the line cloud based on the received images can include implementing one or more techniques that utilizes the 2D images (i.e., the image data of the images) to construct a 3D structure (i.e., the line cloud). In some embodiments, 2D line segments in the 2D images can be derived from 2D points of the 2D images using one or more techniques, such as, for example, Hough transformations, edge detection, feature detection, contour detection, curve detection, random sample consensus (RANSAC), and the like. The derived 2D line segments can be triangulated to construct the line cloud. In some embodiments, 3D points of the point cloud that correspond to the 2D points of the 2D line segments (e.g., end points of the 2D line segments) can be connected in 3D to form a 3D line segment. In some embodiments, 3D line segments can be derived from 3D points of the point cloud, for example based on relative locations of the 3D points.

In some embodiments, for example between steps 104 and 106, or as part of step 106, a selected virtual camera is received. The virtual camera can include, for example, virtual camera extrinsics and intrinsics, such as, for example, a virtual camera pose, including position and orientation in a coordinate space of the point cloud or the line cloud generated in step 104, a virtual camera field of view, a virtual camera viewing window, and the like.

At step 106, a 3D representation of a scene or a structure including points from the point cloud, or line segments from the line cloud, is generated or rendered from a perspective of a selected virtual camera. The perspective of the virtual camera can be defined by virtual camera extrinsics and intrinsics, such as, for example a virtual camera pose, including position and orientation, a virtual camera field of view, a virtual camera viewing window, and the like, as well as cumulative data for all real cameras associated with the images that were used to generate the point cloud or the line cloud, cumulative points of the point cloud or line segments of the line cloud, or a combination thereof. In these embodiments, the 3D representation is generated or rendered from the perspective of the virtual camera without regard to the virtual camera's line of sight which can be established by the virtual camera's relation to the real cameras associated with the images from step 102, the virtual camera's relation to the points of the point cloud from step 104 or the line segments of the line cloud from step 104, or a combination thereof. In some embodiments, the 3D representation is generated or rendered from the perspective of the virtual camera based on the virtual camera's relation to the point cloud or the line cloud. In these embodiments, the 3D representation is generated or rendered from the perspective of the virtual camera based on the virtual camera pose relative to the point cloud or the line cloud. The virtual camera may be referred to as a rendered camera or a synthetic camera. In some embodiments, at step 106, a 2D representation of the 3D representation of the scene or the structure is generated or rendered from the perspective of the virtual camera.

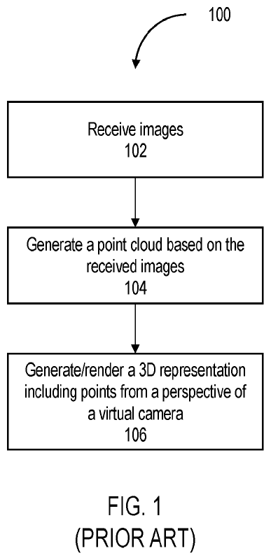

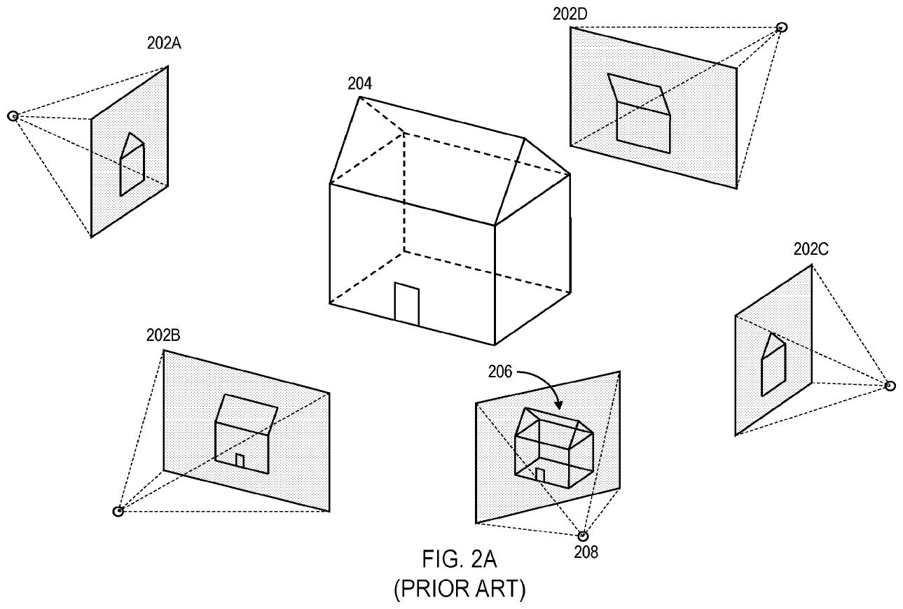

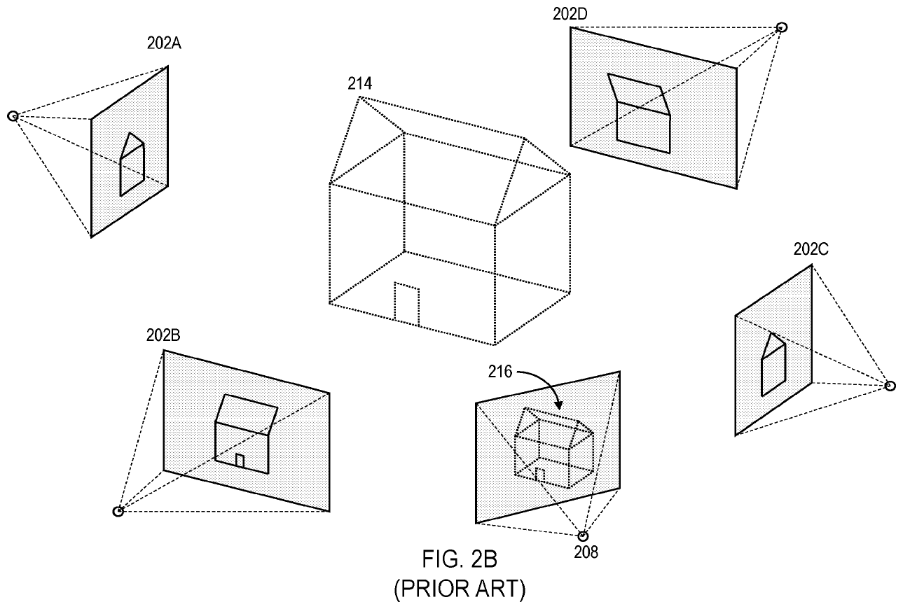

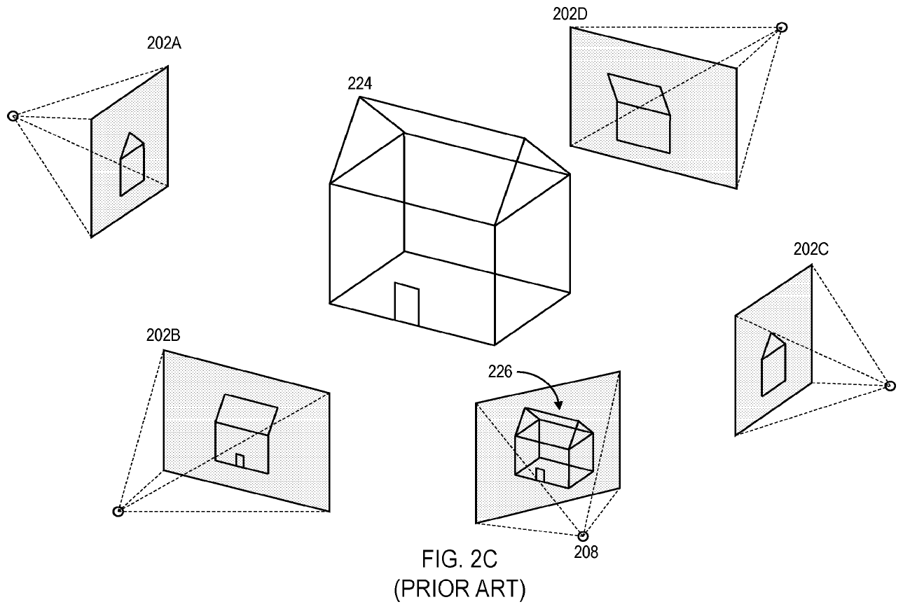

FIG. 2A illustrates a ground-level image capture, according to some embodiments. Images 202A-202D of a subject structure 204 are received. The images 202A-202D can be captured by a data capture device, such as a smartphone or a tablet computer. In some embodiments, a point cloud is generated based on the images 202A-202D. FIG. 2B illustrates a point cloud 214 of the ground-level image capture including the images 202A-202D, according to some embodiments. The point cloud 214 can be generated or rendered from a perspective of virtual camera 208. In this example, the point cloud 214 of FIG. 2B is an example 3D representation of the subject structure 204 of FIG. 2A. In some embodiments, the point cloud is a line cloud. FIG. 2C illustrates a line cloud 224 of the ground-level image capture including images 202A-202D, according to some embodiments. The line cloud 224 can be generated or rendered from a perspective of the virtual camera 208. In this example, the line cloud 224 of FIG. 2C is an example 3D representation of the subject structure 204 of FIG. 2A. In some embodiments, for example with reference to FIG. 2B, a 2D representation 216 of the subject structure 204 including all points from the point cloud 214 is generated or rendered from the perspective of the virtual camera 208, for example based on a pose of the virtual camera 208. In some embodiments, for example with reference to FIGS. 2A and 2C, a 2D representation 206 or 226 of the subject structure 204 including all line segments from the line cloud 224 is generated or rendered from the perspective of the virtual camera 208, for example, based on the pose of the virtual camera 208.

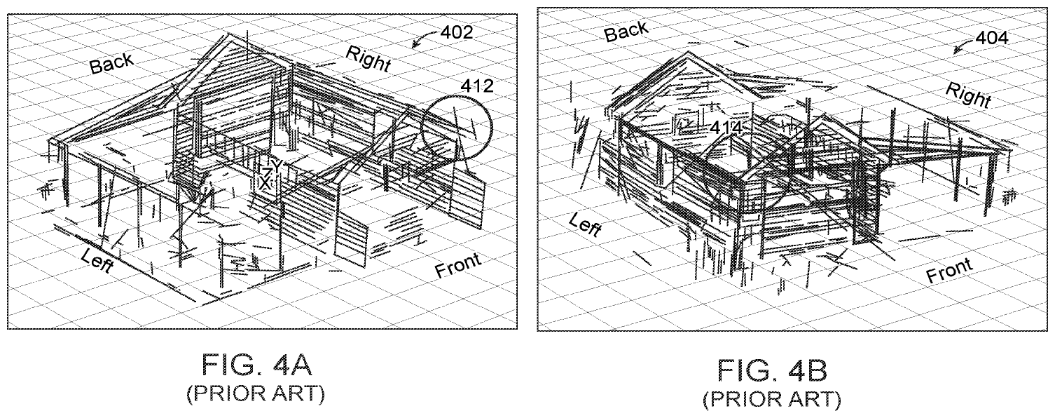

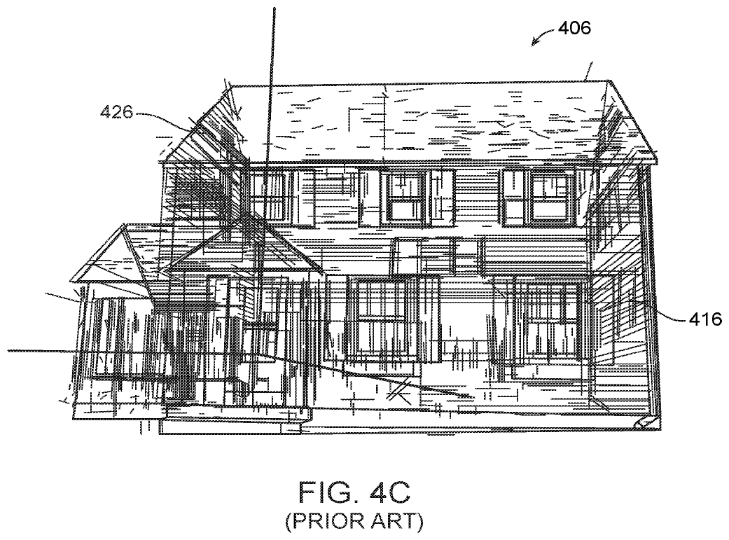

In some embodiments, it may be difficult to interpret the point cloud 214 including all points, the line cloud 224 including all line segments, the 2D representation 216 including all points of the point cloud 214, or the 2D representations 206/226 including all line segments of the line cloud 224, especially if the perspective of the virtual camera 208 associated with the point cloud 214, the line cloud 224, or the 2D representations 206/216/226 is not known by a viewer of the point cloud 214, the line cloud 224, or the 2D representations 206/216/226. For example, in FIGS. 4A and 4B without the coordinate system gridlines as guidance, it is difficult to discern the virtual camera position relative to the depicted point clouds and line clouds as depth cues and vanishing lines of the aggregate features interfere with others. In other words, common optical illusion effects manifest in raw point cloud and raw line cloud outputs. Interactions with the 2D representations 206/216/226 from the virtual camera 208 may act upon points or lines due to apparent visual proximity from the pose of the virtual camera 208 despite the points or lines having significant spatial differences for their real world-counterparts. In one example, region 412 of FIG. 4A depicts points and line segments associated with front and right portions of a subject structure of FIG. 4A. Without the coordinate system gridlines as guidance, it may be difficult to discern between points and line segments associated with the front portion and those associated with the right portion. For example, it may be difficult ascertain end points of the line segments or infer whether the line segments are associated with a front façade or a right façade. In another example, region 414 of FIG. 4B depicts points and line segments associated with front and left portions of a subject structure of FIG. 4B. Without the coordinate system gridlines as guidance, it may be difficult to discern between points and line segments associated with the front portion and those associated with the left portion. For example, it may be difficult ascertain end points of the line segments or infer whether the line segments are associated with a front façade or a left façade. For example, referring to FIG. 4A of a sample point and line cloud associated with a structure, all lines and points are rendered even though a physical camera having the same pose as a virtual camera of FIG. 4A would not observe the aggregate data as shown. In this example, the physical camera having the same pose as the virtual camera of FIG. 4A would observe front and left portions of a subject structure of FIG. 4A, and not back and right portions.

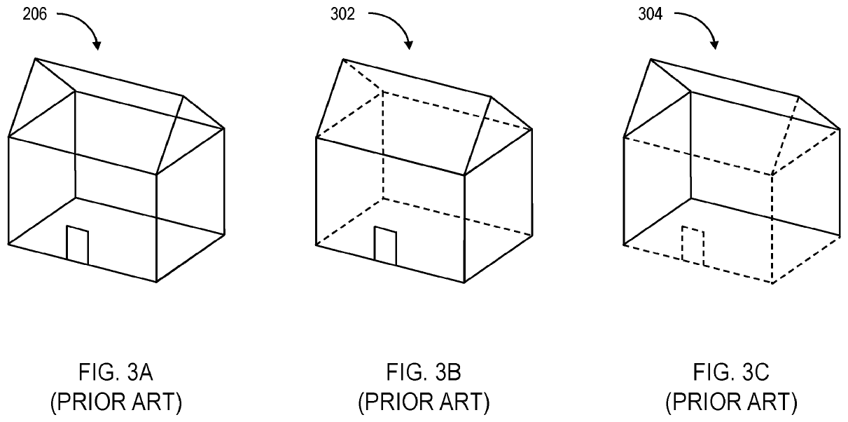

FIGS. 3A-3C illustrate 2D representations 206, 302, and 304, respectively, according to some embodiments. FIG. 3A illustrates a 2D representation 206 illustrated in FIG. 2A. The 2D representation 206 is a 2D representation of the line cloud 224 including all line segments of the line cloud 224. It may be difficult to interpret 2D data of the 2D representation 206 if the pose of the virtual camera 208 is not known by a viewer of the 2D representation 206. In one example, FIG. 3B illustrates a 2D representation 302, wherein the 2D representation 302 is a view of the line cloud 224 with an associated top-front-right pose of a virtual camera relative to the line cloud 224. The dashed lines of the 2D representation 302 of FIG. 3B illustrate those portions of the line cloud 224 that would not be visible or observed by a physical camera at the same location of the virtual camera. In another example, FIG. 3C illustrates a 2D representation 304, wherein the 2D representation 304 is a view of the line cloud 224 with an associated bottom-back-right pose of a virtual camera relative to the line cloud 224. The dashed lines of the 2D representation 304 of FIG. 3C illustrate those portions of the line cloud 224 that would not be visible or observed by a physical camera at the same location of the virtual camera.

In some embodiments, generating or rendering a representation (e.g., a 3D representation or a 2D representation of the 3D representation) including all points from the point cloud or all line segments from the line cloud can be resource intensive and computationally expensive. Spatial accuracy for the aggregate positions of the points or the line segments of the 3D representation, while providing completeness for the 3D representation as collected from the input data (e.g., the images), does not accurately represent the data for a particular rendering camera (e.g., the virtual camera 208). In other words, traditional point clouds, or traditional line clouds, represent aggregate data such that the virtual camera 208 can observe all points of the point cloud 214, or all line segments of the line cloud 224, even though an associated physical camera would only observe those points, or line segments, within its line of sight.

FIGS. 4A-4C illustrate experimental results of point cloud or line cloud rendering of 3D representations 402-406, respectively, according to some embodiments. As illustrated in FIGS. 4A-4C, the spatial accuracy for the aggregate positions of points and line segments of the 3D representations 402-406 provide completeness within 3D coordinate frames of the 3D representations 402-406 are built on, such that any virtual camera position can observe all 3D data of a generated scene. However, the 3D representations 402-406 do not accurately represent the data for a particular rendered camera (e.g., a virtual camera) associated with each of the 3D representations 402-406. FIG. 4A illustrates the 3D representation 402 including a sample point and line cloud associated with a structure, and all points and lines are rendered even though a physical camera having the same pose as a virtual camera of FIG. 4A would not observe the aggregate data as shown. Similarly, FIG. 4B illustrates a 3D representation 404 including a sample point and line cloud associated with a structure, and all points and lines are rendered even though a physical camera having the same pose as a virtual camera of FIG. 4B would not observe the aggregate data as shown. FIG. 4C illustrates the 3D representation 406 that includes a projection of aggregate point and line segment data onto a real camera pose image. Lines 416 and 426, representing 3D data for the sides of the depicted house are rendered for the virtual camera of FIG. 4C even though the real camera pose at that same location does not actually observe such 3D data.

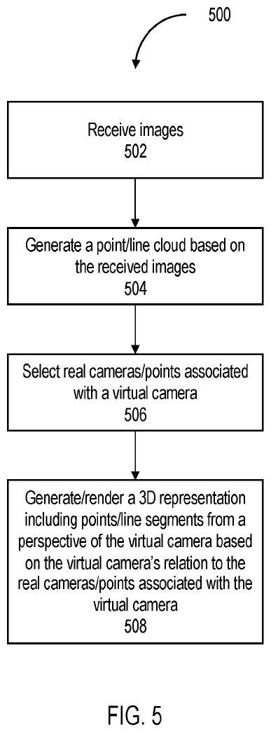

FIG. 5 illustrates a method 500 for generating or rendering a 3D representation, according to some embodiments. At step 502, images are received. A data capture device, such as a smartphone or a tablet computer, can capture the images. Other examples of data capture devices include drones and aircraft. The images can include image data (e.g., color information) and/or depth data (e.g., depth information). The image data can be from an image sensor, such as a charge coupled device (CCD) sensor or a complementary metal-oxide-semiconductor (CMOS) sensor, embedded within the data capture device. The depth data can be from a depth sensor, such as a LiDAR sensor or a time-of-flight sensor, embedded within the data capture device.

At step 504, a point cloud is generated based on the received images. A point cloud is a set of data points in a 3D coordinate system. The point cloud can represent co-visible points across the images. Generating the point cloud based on the received images can include implementing one or more techniques, such as, for example, a structure-from-motion (SfM) technique which utilizes two-dimensional (2D) images (i.e., the image data of the images) to construct a 3D structure (i.e., the point cloud). In some embodiments, the point cloud is a line cloud. A line cloud is a set of data line segments in a 3D coordinate system. The line cloud can represent co-visible line segments across the images. Generating the line cloud based on the received images can include implementing one or more techniques that utilizes the 2D images (i.e., the image data of the images) to construct a 3D structure (i.e., the line cloud). In some embodiments, 2D line segments of the 2D images can be derived from 2D points of the 2D images using one or more techniques, such as, for example, Hough transformations, edge detection, feature detection, contour detection, curve detection, random sample consensus (RANSAC), and the like. The derived 2D line segments can be triangulated to construct the line cloud. In some embodiments, 3D points of the point cloud that correspond to the 2D points of the 2D line segments (e.g., end points of the 2D line segments) can be connected in 3D to form a 3D line segment. In some embodiments, 3D line segments can be derived from 3D points of the point cloud, for example based on relative locations of the 3D points. In some embodiments, the point cloud, or the line cloud, can be segmented, for example, based on a subject of interest, such as a structure. In some embodiments, the received images are segmented, for example, based on a subject of interest, such as a structure, and the point cloud, or the line cloud, is generated based on the segmented images. Generating the point cloud or the line cloud includes calculating, for each image, a pose of a real camera associated with the image. The pose of the real camera can include position data and orientation data associated with the real camera.

In some embodiments, generating the point cloud can include generating metadata for each point of the point cloud or for each end point of each line segment of the line cloud. The metadata can be derived from the images that were used to triangulate the point. In some examples, the metadata can include data describing real cameras associated with the images that were used to triangulate the point. For example, metadata including data describing real cameras associated with the images can include real camera extrinsics and intrinsics, such as, for example, a real camera pose, including position and orientation in a coordinate space of the point cloud or the line cloud, a real camera field of view, a real camera viewing window, and the like. In some examples, the metadata can include data describing the images that were used to triangulate the point. In these examples, the metadata can include capture times of the images. In some examples, the metadata can include data describing specific pixels of the images that were used to triangulate the point. In these examples, the metadata can include color values (e.g., red-, green-, and blue-values) of the specific pixels, semantic labels (e.g., structure, not structure, etc.) of the specific pixels, and the like. In some examples, the metadata can include a visibility value. The visibility value can indicate which real cameras observe the point. The visibility value can be generated based on the 3D angles between the point and optical centers of real cameras associated with the images that were used to triangulate the point. Pose typically includes position and orientation. The point is a position (e.g., X, Y, Z coordinate value) in the coordinate space of the point cloud or the line cloud. The visibility value can be used to describe an orientation of the point. The visibility value and the position of the point together can be used to define a pose of the point.

In some embodiments, for example between steps 504 and 506, or as part of step 506, a selected virtual camera is received. The virtual camera can include, for example, virtual camera extrinsics and intrinsics, such as, for example, a virtual camera pose, including position and orientation in a coordinate space of the point cloud or the line cloud generated in step 504, a virtual camera field of view, a virtual camera viewing window, and the like. In some embodiments, a virtual camera is selected at an arbitrary location relative to the point cloud or the line cloud; in some embodiments, a virtual camera is selected within a spatial constraint. The spatial constraint can impose restrictions on the pose of the virtual camera. In some embodiments, the spatial constraint is such that a frustum of the virtual camera shares at least ten percent of the field of view of two real cameras associated with the point cloud or the line cloud.

In some embodiments, at step 506, real cameras associated with a selected virtual camera are selected. The real cameras associated with the selected virtual camera can include a subset of all the real cameras. In some embodiments, selecting the real cameras associated with the virtual camera can include comparing the poses of the real cameras to a pose of the virtual camera. The pose of the virtual camera can include position data and orientation data associated with the virtual camera. In some embodiments, comparing the poses of the real cameras to the pose of the virtual camera includes comparing 3D positions of the real cameras to a position of the virtual camera. In some embodiments, if a distance between the position of the virtual camera and the position of a real camera is less than or equal to a threshold distance value, the real camera can be considered associated with, or is associated with, the virtual camera. In one example, the threshold distance value can be a predetermined distance value, where the predetermined distance value can be in modeling space units, render space units, or real-world units such as within five meters. In this example, all points including metadata describing the real cameras that are within the predetermined distance value of the virtual camera are selected (i.e., considered to be associated with the virtual camera). In this example, the threshold distance value is an absolute value (i.e., absolute distance). In some examples the threshold distance is an angular relationship, such as an azimuth of a real camera as measured from the optical axis of a real camera compared the azimuth of a virtual camera. A real camera with an azimuth within ninety degrees of a virtual camera may be eligible for selection, and the points associated with such selected real camera are selectively rendered. In some examples, a threshold distance value satisfies both a predetermined distance value and an angular relationship.

In some embodiments, selecting the real cameras associated with the virtual camera can include selecting the real cameras that are the k-nearest neighbors of the virtual camera, for example by performing a k-nearest neighbors search. In these embodiments, k can be an absolute value (e.g., eight) or a relative value (e.g., relative to the total number of real cameras, relative to the number of real cameras within a threshold distance of the virtual camera, relative to distances between the real cameras and the virtual camera, relative to a frustrum of the virtual camera, etc.).

In some embodiments, selecting the real cameras associated with the virtual camera can include comparing fields of view of the real cameras with a field of view, or a view frustum, of the virtual camera. In some embodiments, if a field of view of a real camera overlaps a field of view of the virtual camera, the real camera is considered to be associated with the virtual camera. In some embodiments, if a field of view of real camera shares at least a threshold of a field of view of the virtual camera, the field of view of the real camera is considered to overlap the field of view of the virtual camera. Examples of thresholds include five percent, ten percent, fifteen percent, and the like.

In some embodiments, selecting the real cameras associated with the virtual camera can include comparing capture times, or timestamps, associated with the real cameras. A capture time, or timestamp, associated with a real camera can represent a time the real camera captured an associated image. In some embodiments, if several real cameras are associated with the virtual camera, for example by comparing the poses of the real cameras to the pose of the virtual camera, by comparing the fields of views of the real cameras to the field of view of the virtual camera, or both, capture times associated with the several real cameras associated with the virtual camera can be compared to one another, and real cameras whose associated capture times are temporally proximate to one another or temporally proximate to of one of the several real cameras can be associated with the virtual camera. In some embodiments, the temporal proximity can be relative to an absolute value (i.e., absolute time) or a relative value (e.g., relative to capture times, or multiples thereof, associated with all the real cameras or a subset of the real camera (i.e., the several real cameras)). Examples of absolute values include thirty seconds, sixty seconds, ninety seconds, and the like. In some examples, a relative value of ten percent of a total capture time defines real cameras that are temporally proximate. A virtual camera can be placed relative to a point cloud, and in some examples a real camera geometrically close to the virtual camera (e.g., by threshold value discussed elsewhere) is identified, and other real cameras captured within the relative timestamp of the geometrically close real camera are selected. In some embodiments, a virtual camera can be placed according to a time stamp, and the real cameras within a relative value are selected.

In some embodiments, selecting the real cameras associated with the virtual camera can include comparing the poses of the real cameras to the pose of the virtual camera, comparing the fields of views of the real cameras to the field of view of the virtual camera, comparing the capture times associated with the real cameras, or some combination thereof.

In some embodiments, at step 506, real cameras are associated with a selected virtual camera. In some embodiments, associating the real cameras with the virtual camera can include comparing poses of the real cameras to a pose of the virtual camera, comparing fields of view of the real cameras to a field of view of the virtual camera, comparing capture times associated with the real cameras, or some combination thereof.

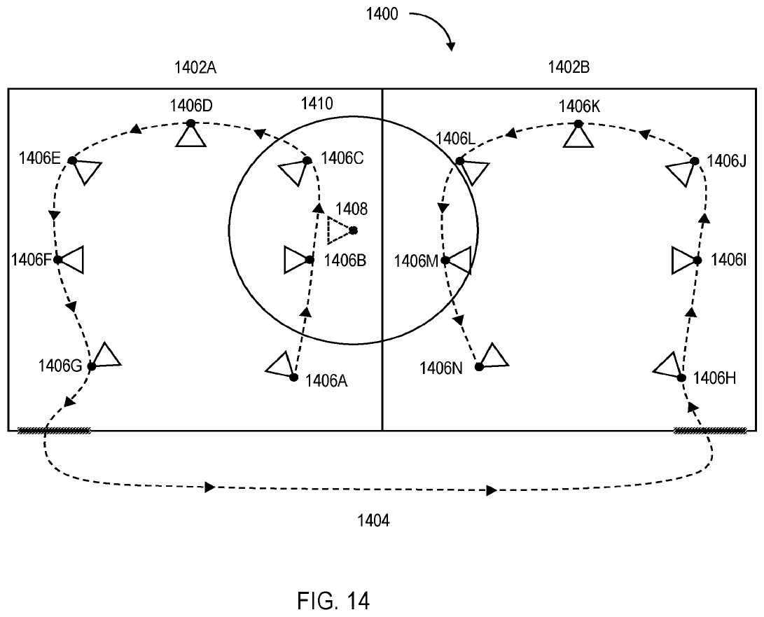

Referring briefly to FIG. 14, it illustrates a capture 1400 of two adjacent rooms 1402A and 1402B, according to some embodiments. Capture path 1404 starts in the first room 1402A at real camera 1406A and ends in the second room 1402B at real camera 1406N. Each real camera of the real cameras 1406A-1406N captures an image with the illustrated camera pose. A subset of the real cameras 1406A-1406N are associated with virtual camera 1408.

In some embodiments, the real cameras 1406A-1406N that are k-nearest neighbors of the virtual camera 1408 are associated with the virtual camera 1408, where k is a relative value defined by boundary 1410. In these embodiments, the real cameras 1406B, 1406C, and 1406M are within the boundary 1410 and are associated with the virtual camera 1408.

In some embodiments, the real cameras 1406A-1406N that have a field of view that overlaps a field of view of the virtual camera 1408 are associated with the virtual camera 1408. In these embodiments, the real cameras 1406B and 1406C are associated with the virtual camera 1408. In the k-nearest neighbors example, the real cameras 1406B, 1406C, and 1406M are associated with the virtual camera 1408. The fields of view of the real cameras 1406B and 1406C overlap with the field of view of the virtual camera 1408, whereas the field of view of the real camera 1406M does not overlap with the field of view of the virtual camera 1408. Therefore, the real camera 1406M should not be associated with, or should be disassociated from, the virtual camera 1408 based on the field of view of the real camera 1406M not overlapping the field of view of the virtual camera 1408.

In some embodiments, the real cameras 1406A-1406N whose capture times are temporally proximate to one another are associated with the virtual camera 1408. In the k-nearest neighbors example, the real cameras 1406B, 1406C, and 1406M are associated with the virtual camera 1408. The temporal proximity can be relative to an absolute value (i.e., an absolute time) or a relative value (i.e., relative to capture times, or multiples thereof, associated with all the real cameras 1406A-1406N or a subset of the real cameras 1406A-1406N, such as the real cameras 1406B, 1406C, and 1406M). In this example, the capture times of the real cameras 1406B and 1406C are temporally proximate to one another, whereas the capture time of the real camera 1406M is not temporally proximate to either of the real cameras 1406B and 1406C. Therefore, the real camera 1406M should not be associated with, or should be disassociated from, the virtual camera 1408 based on the real camera 1406M not being temporally proximate to the real cameras 1406B and 1406C.

Referring back to FIG. 5, in some embodiments, at step 506, points of the point cloud or end points of line segments of the line cloud associated with the selected virtual camera are selected. The points associated with the selected virtual camera can include a subset of all the points of the point cloud or all the end points of the line segments of the line cloud. In some embodiments, selecting points associated with the virtual camera can include selecting the points based on metadata associated with the points.

In some examples, selecting the points based on the metadata can include comparing data describing real cameras associated with the images that were used to triangulate the points to data describing the virtual camera. This can include, for example, comparing real camera extrinsics and intrinsics, comparing poses of the real cameras to a pose of the virtual camera, comparing fields of view of the real cameras to a field of view of the virtual camera, or a combination thereof. In some embodiments, if a distance between the position of the virtual camera and the position of a real camera is less than or equal to a threshold distance value, points including metadata describing the real camera are selected (i.e., considered to be associated with the virtual camera). In one example, the threshold distance value can be a predetermined distance value, where the predetermined distance value can be in modeling space units, render space units, or real-world units such as five meters. In this example, all points including metadata describing the real cameras that are within the predetermined distance value of the virtual camera are selected (i.e., considered to be associated with the virtual camera). In this example, the threshold distance value is an absolute value (i.e., absolute distance). In some examples the threshold distance is an angular relationship, such as an azimuth of a real camera as measured from the optical axis of a real camera compared the azimuth of the virtual camera. A real camera with an azimuth within ninety degrees of the virtual camera may be eligible for selection, and the points associated with such selected real camera are selectively rendered. In some examples, a threshold distance value satisfies both a predetermined distance value and an angular relationship.

In some embodiments, points including metadata describing the real cameras that are the k-nearest neighbors of the virtual camera, for example by performing a k-nearest neighbors search, are selected (i.e., considered to be associated with the virtual camera). In these embodiments, k can be an absolute value (e.g., eight) or a relative value (e.g., relative to the total number of real cameras, relative to the number of real cameras within a threshold distance of the virtual camera, relative to distances between the real cameras and the virtual camera, relative to a frustrum of the virtual camera, etc.).

In some embodiments, if a field of view of the virtual camera overlaps a field of view of a real camera, points including metadata describing the real camera are selected (i.e., considered to be associated with the virtual camera).

In some examples, selecting the points based on the metadata associated with the points can include comparing data describing the images, or the real cameras associated with the images, that were used to triangulate the points to one another. This can include, for example, comparing capture times associated with the images, or the real cameras associated with the images.

In some embodiments, if several points are selected (i.e., associated with the virtual camera), for example by comparing the poses of the real cameras to the pose of the virtual camera, by comparing the fields of views of the real cameras to the field of view of the virtual camera, or both, capture times associated with the images, or the real cameras associated with the images, associated with the several points can be compared to one another. Points associated with images, or real cameras associated with images, whose associated capture times are temporally proximate to one another or temporally proximate to one of the images, or the real cameras associated with the images, associated with the several points can be selected (i.e., considered to be associated with the virtual camera). In some embodiments, the temporal proximity can be relative to an absolute value (i.e., absolute time) or a relative value (e.g., relative to capture times, or multiples thereof, associated with all the real cameras or a subset of the real camera (i.e., the real cameras associated with the several points)). Examples of absolute values include thirty seconds, sixty seconds, ninety seconds, and the like. In some examples, a relative value of ten percent of a total capture time defines real cameras that are temporally proximate. A virtual camera can be placed relative to a point cloud, and in some examples a real camera geometrically close to the virtual camera (e.g., by threshold value discussed elsewhere) is identified, and other real cameras captured within the relative timestamp of the geometrically close real camera are selected. In some embodiments, a virtual camera can be placed according to a time stamp, and the real cameras within a relative value are selected.

In some examples, selecting the points based on the metadata associated with the points can include comparing data describing specific pixels of the images that were used to triangulate the points to one another, to a set of values/labels, or a combination thereof. This can include, for example, comparing color values to one another or to a set of color values, or comparing semantic labels to one another or to a set of semantic labels, or a combination thereof.

In some embodiments, color values are compared to one another or to a set of color values, for example that are commonly associated with a structure. In some embodiments, if color values of adjacent points are similar to one another or if color values of points are similar to a set of color values that are commonly associated with a structure, points including metadata describing the color values can be selected (i.e., considered to be associated with the virtual camera). In some embodiments, if a semantic label of the point is associated with a structure, the point including metadata describing the semantic label is selected (i.e., considered to be associated with the virtual camera).

In some examples, selecting the points based on the metadata can include comparing visibility values to one another, to the virtual camera, or a combination thereof.

In some embodiments, a virtual camera can be matched to a first real camera and a second real camera. The first real camera can observe a first point, a second point, and a third point, and the second real camera can observe the second point, the third point, and a fourth point. The points that satisfy a visibility value for both the first real camera and the second real camera can be selected. In other words, the points that are observed by both the first real camera and the second real camera can be selected. In this example, the second point and the third point satisfy the visibility value for both the first real camera and the second real camera.

In some embodiments, a viewing frustum of a virtual camera can include first through seventh points. A first real camera can observe the first through third points, a second real camera can observe the second through fourth points, and a third camera can observe the fifth through seventh points. The points that have common visibility values can be selected. In other words, the points that are observed by several real cameras can be selected. In this example, the second point and the third point satisfy the visibility value for both the first real camera and the second real camera.

In some embodiments, at step 506, points of the point cloud or end points of line segments of the line cloud are associated with the virtual camera. In some embodiments, associating the points can include selecting the points based on metadata associated with the points.

At step 508, a 3D representation of a scene or a structure including points from the point cloud or the segmented point cloud, or line segments from the line cloud or the segmented line cloud, is generated or rendered from a perspective of the virtual camera. The perspective of the virtual camera can be defined by virtual camera extrinsics and intrinsics, such as, for example, a virtual camera pose, including position and orientation, a virtual camera field of view, a virtual camera viewing window, and the like. In some embodiments, the 3D representation is generated or rendered from the perspective of the virtual camera based on the virtual camera's relation to the real cameras associated with the virtual camera (as selected/associated at step 506), the virtual camera's relation to the points associated with the virtual camera (as selected/associated at step 506), or a combination thereof. In some embodiments, generating or rendering the 3D representation includes selecting points of the point cloud or the segmented point cloud, or line segments of the line cloud or the segmented line cloud, that are visible or observed by the real cameras associated with the virtual camera, and generating or rendering the 3D representation including the selected points, or line segments from the perspective of the virtual camera. In some examples, selecting the points or the line segments visible or observed by the real cameras associated with the virtual camera can include reprojecting the points or the line segments into the images captured by the real cameras associated with the virtual camera, and selecting the reprojected points or line segments. In some embodiments, generating or rendering the 3D representation includes selecting points of the point cloud or the segmented point cloud, or line segments of the line cloud or the segmented line cloud, that originated from images captured by the real cameras associated with the virtual camera, and generating or rendering the 3D representation including the selected points, or line segments. In some examples, each point or line segment can include metadata that references which subset of images the point or line segment originated from. In some examples, selecting the points or the line segments that originated from images captured by the real cameras associated with the virtual camera can include reprojecting the points or the line segments into the images captured by the real cameras associated with the virtual camera, and selecting the reprojected points or line segments. In some embodiments, generating or rendering the 3D representation includes generating or rendering the 3D representation including the points associated with the virtual camera (as selected/associated at step 506). In some embodiments, a 2D representation of the 3D representation is generated or rendered from the perspective of the virtual camera.

In some embodiments, step 508 includes generating or rendering color values for the 3D representation of the scene or the structure, for example for all points or a subset of points of the 3D representation. A color value for a point in the 3D representation can be generated based on the metadata associated with the points from the point cloud or the segmented point cloud, or end points of line segments of the line cloud or the segmented line cloud. As disclosed herein, each point of the point cloud or the segmented point cloud, and each end point of each line segment of the line cloud or the segmented line cloud includes metadata, and the metadata can include color values (e.g., red-, green-, blue-values) of the specific pixels of the images that were used to triangulate the point. Referring briefly to point cloud generation, each point is generated from at least a first pixel in a first image and a second pixel in a second image, though additional pixels from additional images can be used as well. The first pixel has a first color value and the second pixel has a second color value. The color value for the point can be generated by selecting a predominant color value of the first color value and the second color value, by calculating an average color value of the first color value and the second color value, and the like. In some embodiments, the predominant color value is the color value of the pixel of the image whose associated real camera is closest to the virtual cameras, which can be selected by comparing distances between the virtual camera and the real cameras associated with the images.

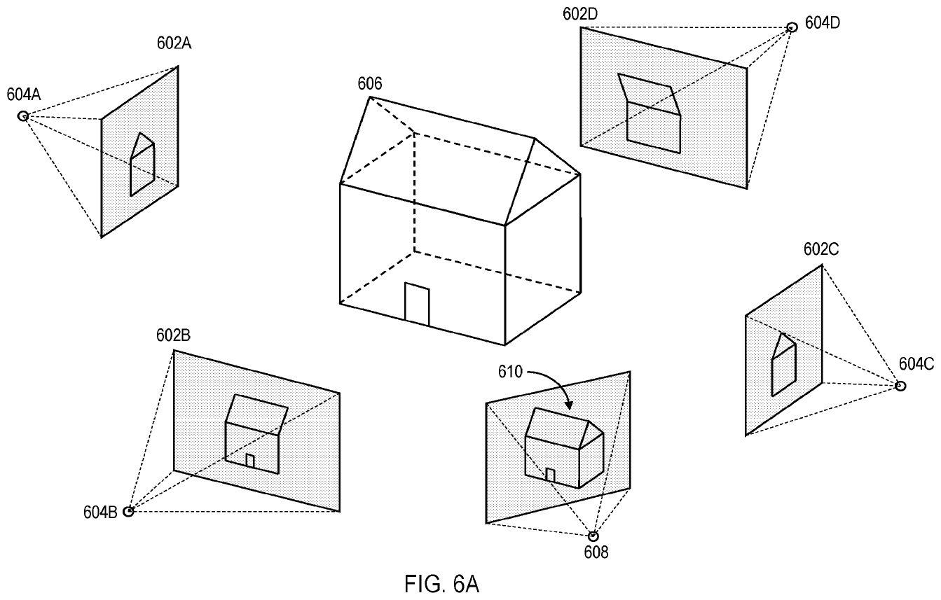

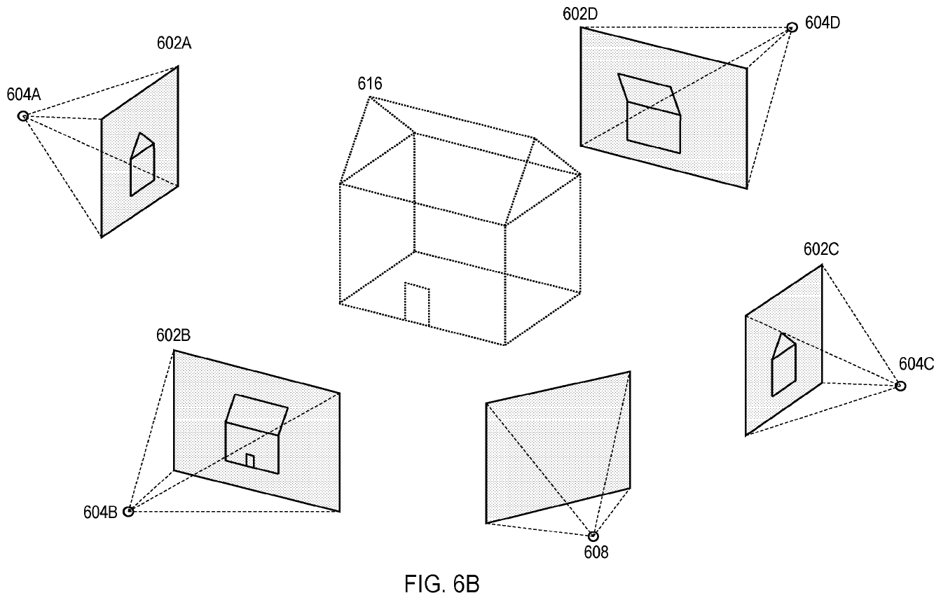

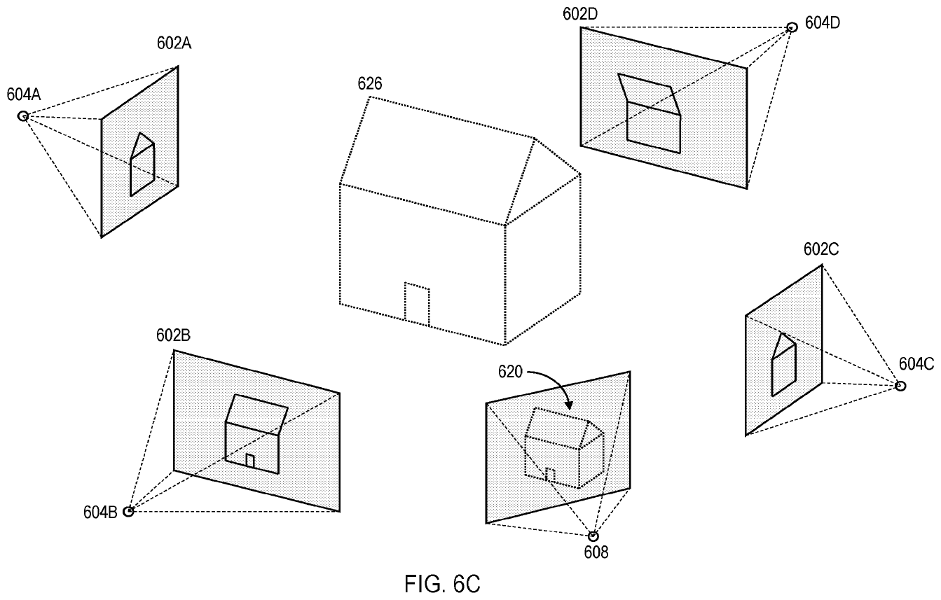

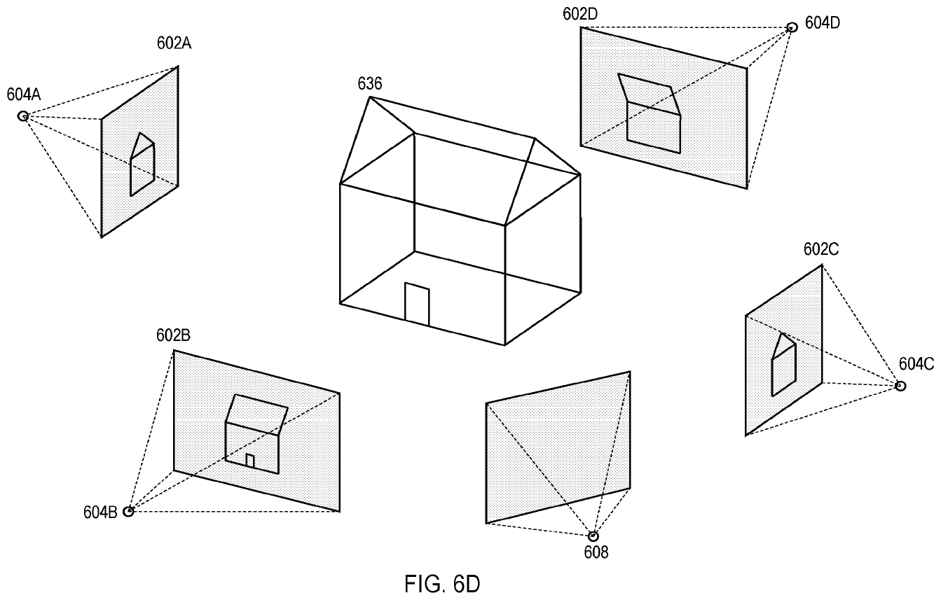

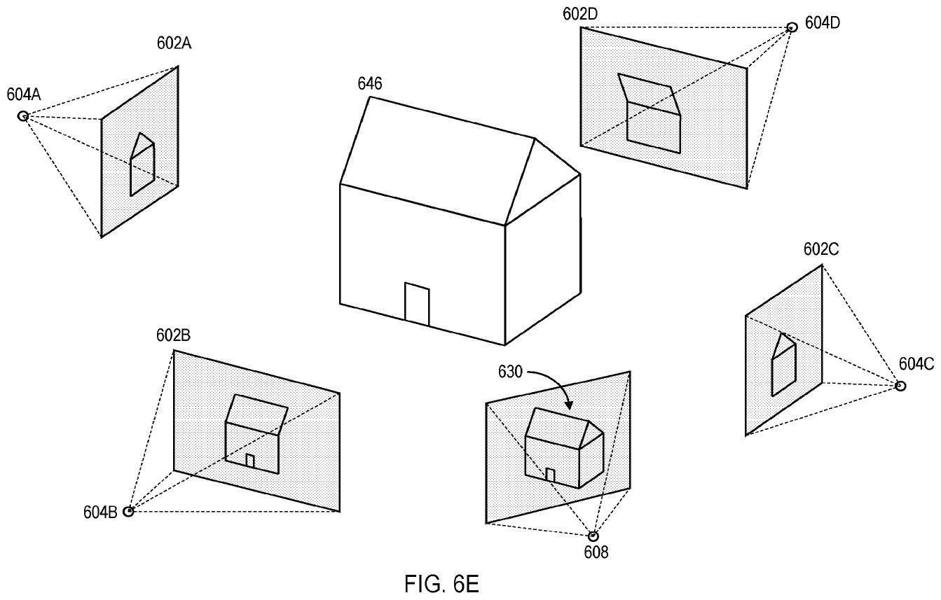

FIG. 6A illustrates a ground-level image capture, according to some embodiments. Images 602A-602D are received. The images 602A-602D can be captured by a data capture device, such as a smartphone or a tablet computer. In some embodiments, a point cloud is generated based on the images 602A-602D. FIG. 6B illustrates a point cloud 616 of the ground-level image capture including images 602A-602D, according to some embodiments. In this example, the point cloud 616 of FIG. 6B is an example 3D representation of subject structure 606 of FIG. 6A. In some embodiments, the point cloud is a line cloud. FIG. 6D illustrates a line cloud 636 of the ground-level image capture including images 602A-602D, according to some embodiments. In this example, the line cloud 636 of FIG. 6D is an example 3D representation of the subject structure 606 of FIG. 6A. In some embodiments, the point cloud 616, or the line cloud 636, can be segmented, for example, based on a subject of interest, such as the subject structure 606. In some embodiments, the images 602A-602D are segmented, for example, based on the subject structure 606, and the point cloud 616, or the line cloud 636, is generated based on the segmented images. Generating the point cloud 616 or the line cloud 636 includes calculating, for each image 602A-602D, poses for real cameras 604A-604D associated with the images 602A-602D, respectively. In some embodiments, generating the point cloud 616 or the line cloud 636 includes generating metadata for each point of the point cloud 616 or each end point of each line segment of the line cloud 636.

In some embodiments, the real cameras 604A-604D associated with the virtual camera 608 are selected. For example, the real cameras 604A-604D associated with the virtual camera 608 are selected by comparing the poses of the real cameras 604A-604D and a pose of the virtual camera 608, by comparing the fields of view of the real cameras 604A-604D and a field of view of the virtual camera 608, by comparing capture times associated with the images 602A-602D, or some combination thereof. In some embodiments, the real cameras 604A-604D are associated with the virtual camera 608 by comparing the poses of the real cameras 604A-604D and a pose of the virtual camera 608, by comparing the fields of view of the real cameras 604A-604D and a field of view of the virtual camera 608, by comparing capture times associated with the images 602A-602D, or some combination thereof. In the example illustrated in FIGS. 6A-6E, the real cameras 604B and 604C are considered to be associated with, or are associated with, the virtual camera 608. In some embodiments, points of the point cloud 616 or end points of line segments of the line cloud 636 associated with the virtual camera 608 are selected. For example, the points of the point cloud 616 or the end points of the line segments of the line cloud 636 are associated with the virtual camera 608 by selecting points based on metadata associated with the points.

A 3D representation of the subject structure 606 including points from the point cloud 616, or line segments from the line cloud 636, is generated or rendered from the perspective of the virtual camera 608, for example, based on the pose of the virtual camera 608 and the real cameras 604B-604C associated with the virtual camera 608, the points of the point cloud 616 or the end points of the line segments of the line cloud 636 associated with the virtual camera 608, or a combination thereof.

FIG. 6C illustrates a modified point cloud 626 (also referred to as “3D representation 626”), according to some embodiments. The modified point cloud 626 is a modified version of the point cloud 616. In some embodiments, for example as illustrated in FIG. 6C, generating or rendering 3D representation 626 includes selecting points of the point cloud 616 that are visible or observed by the real cameras 604B-604C associated with the virtual camera 608, and generating or rendering the 3D representation 626 including the selected points. In some embodiments, generating or rendering the 3D representation 626 includes selecting points of the point cloud 616 that originated from the images 602B-602C captured by the real cameras 604B-604C associated with the virtual camera 608, and generating or rendering the 3D representation 626 including the selected points. In some embodiments, generating or rendering the 3D representation 626 includes generating or rendering the 3D representation 626 including the points associated with the virtual camera 608. As illustrated in FIG. 6C, the 3D representation 626 includes aggregate data collected by images 602B-602C. A 2D representation 620 of the 3D representation 626 is generated or rendered from the perspective of the virtual camera 608.

FIG. 6E illustrates a modified line cloud 646 (also referred to as “3D representation 646”), according to some embodiments. The modified line cloud 646 is a modified version of the line cloud 636. In some embodiments, for example as illustrated in FIG. 6E, generating or rendering 3D representation 646 includes selecting line segments of the line cloud 636 that are visible or observed by the real cameras 604B-604C associated with the virtual camera 608, and generating or rendering the 3D representation 646 including the selected line segments. In some embodiments, generating or rendering the 3D representation 646 includes selecting line segments of the line cloud 636 that originated from the images 602B-602C captured by the real cameras 604B-604C associated with the virtual camera 608, and generating or rendering the 3D representation 646 including the selected line segments. In some embodiments, generating or rendering the 3D representation 646 includes generating or rendering the 3D representation 646 including the points associated with the virtual camera 608. As illustrated in FIG. 6E, the 3D representation 646 includes aggregate data collected by images 602B-602C. 2D representations 610 and 630 of the 3D representation 646 are generated or rendered from the perspective of the virtual camera 608.

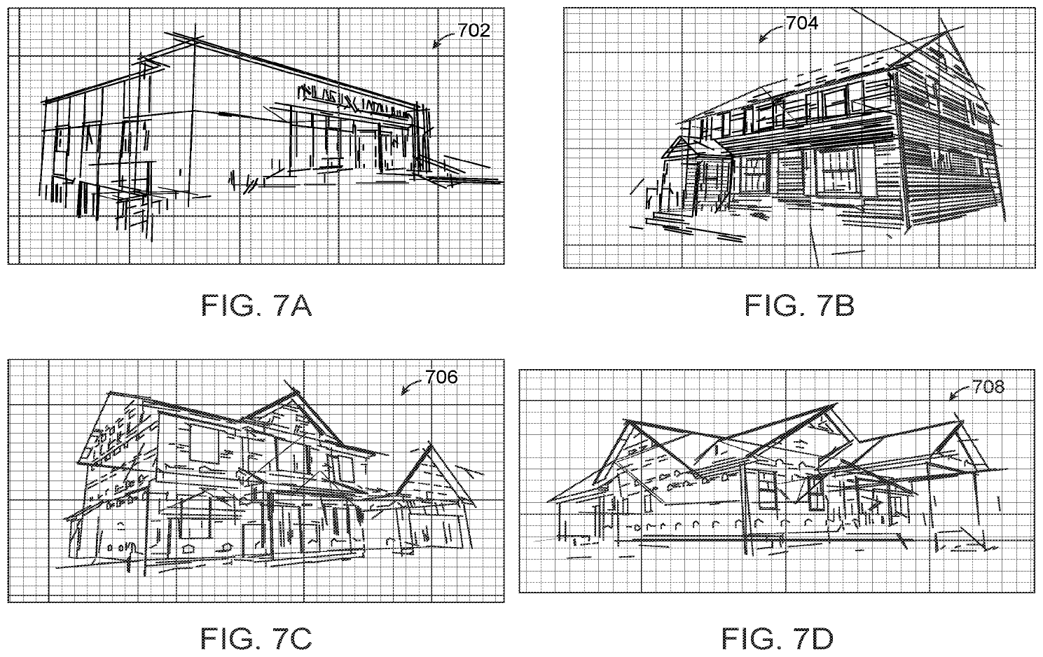

FIGS. 7A-7D illustrate experimental results of selective point cloud or line cloud rendering of 3D representations 702-708, respectively, according to some embodiments. The 3D representations 702-708 accurately represent the spatial data for the subject buildings appearance and features according to a particular rendered camera (e.g., virtual camera) associated with each of the 3D representations 702-708. These serve as pose-dependent de-noised renderings of the subject structures, in that points or lines not likely to be visible or observed from the virtual camera are culled.

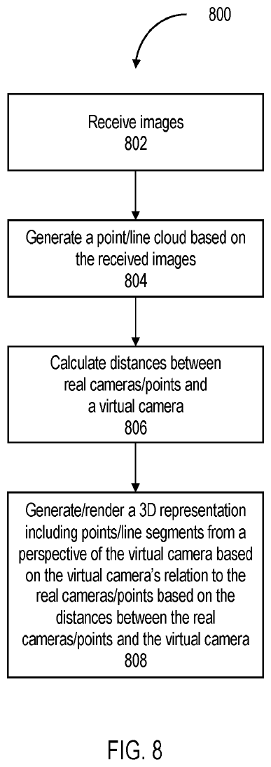

FIG. 8 illustrates a method 800 for generating or rendering a 3D representation, according to some embodiments. At step 802, images are received. A data capture device, such as a smartphone or a tablet computer, can capture the images. Other examples of data capture devices include drones and aircraft. The images can include image data (e.g., color information) and/or depth data (e.g., depth information). The image data can be from an image sensor, such as a charge coupled device (CCD) sensor or a complementary metal-oxide-semiconductor (CMOS) sensor, embedded within the data capture device. The depth data can be from a depth sensor, such as a LiDAR sensor or a time-of-flight sensor, embedded within the data capture device.

At step 804, a point cloud is generated based on the received images. A point cloud is a set of data points in a 3D coordinate system. The point cloud can represent co-visible points across the images. Generating the point cloud based on the received images can include implementing one or more techniques, such as, for example, a structure-from-motion (SfM) technique which utilizes 2D images (i.e., the image data of the images) to construct a 3D structure (i.e., the point cloud). In some embodiments, the point cloud is a line cloud. A line cloud is a set of data line segments in a 3D coordinate system. The line cloud can represent co-visible line segments across the images. Generating the line cloud based on the received images can include implementing one or more techniques that utilizes the 2D images (i.e., the image data of the images) to construct a 3D structure (i.e., the line cloud). In some embodiments, 2D line segments of the 2D images can be derived from 2D points of the 2D images using one or more techniques, such as, for example, Hough transformations, edge detection, feature detection, contour detection, curve detection, random sample consensus (RANSAC), and the like. The derived 2D line segments can be triangulated to construct the line cloud. In some embodiments, 3D points of the point cloud that correspond to the 2D points of the 2D line segments (e.g., end points of the 2D line segments) can be connected in 3D to form a 3D line segment. In some embodiments, 3D line segments can be derived from 3D points of the point cloud, for example based on relative locations of the 3D points. In some embodiments, the point cloud, or the line cloud, can be segmented, for example, based on a subject of interest, such as a structure. In some embodiments, the received images are segmented, for example, based on a subject of interest, such as a structure, and the point cloud, or the line cloud, is generated based on the segmented images. Generating the point cloud or the line cloud includes calculating, for each image, a pose of a real camera associated with the image. The pose of the real camera can include position data and orientation data associated with the real camera.

In some embodiments, generating the point cloud can include generating metadata for each point of the point cloud or for each end point of each line segment of the line cloud. The metadata can be derived from the images that were used to triangulate the point. In some examples, the metadata can include data describing real cameras associated with the images that were used to triangulate the point. For example, metadata including data describing real cameras associated with the images can include real camera extrinsics and intrinsics, such as, for example, a real camera pose, including position and orientation in a coordinate space of the point cloud or the line cloud, a real camera field of view, a real camera viewing window, and the like. In some examples, the metadata can include data describing the images that were used to triangulate the point. In these examples, the metadata can include capture times of the images. In some examples, the metadata can include data describing specific pixels of the images that were used to triangulate the point. In these examples, the metadata can include color values (e.g., red-, green-, and blue-values) of the specific pixels, semantic labels (e.g., structure, not structure, etc.) of the specific pixels, and the like. In some examples, the metadata can include a visibility value. The visibility value can be generated based on the 3D angles between the point and optical centers of real cameras associated with the images that were used to triangulate the point. The visibility value and the 3D position of the point can be used to define a pose of the point.

In some embodiments, for example between steps 804 and 806, or as a part of step 806, a selected virtual camera is received. The virtual camera can include, for example, virtual camera extrinsics and intrinsics, such as, for example, a virtual camera pose, including position and orientation in a coordinate space of the point cloud or the line cloud generated in step 804, a virtual camera field of view, a virtual camera viewing window, and the like. In some embodiments, a virtual camera is selected at an arbitrary location relative to the point cloud or the line cloud; in some embodiments, a virtual camera is selected within a spatial constraint. The spatial constraint can impose restrictions on the pose of the virtual camera. In some embodiments, the spatial constraint is such that a frustum of the virtual camera shares at least ten percent of the field of view of two real cameras associated with the point cloud or the line cloud.

In some embodiments, at step 806, distances between the real cameras and a selected virtual camera are calculated. In some embodiments, calculating distances between the real cameras and the virtual camera can include comparing the poses of the real cameras to a pose of the virtual camera. Comparing the poses of the real cameras to the pose of the virtual camera can include comparing 3D positions of the real cameras to a 3D position of the virtual camera. In some embodiments, calculating distances between the real cameras and the virtual camera can include calculating, in 3D space, linear distances between the real cameras and the virtual cameras.

In some embodiments, at step 806, distances between the points of the point cloud or the end points of the line segments of the line cloud are calculated. In some embodiments, calculating distances between the points and the virtual camera can include comparing the poses of the points to a pose of the virtual camera. Comparing the poses of the points to the pose of the virtual camera can include comparing 3D positions of the points to a 3D position of the virtual camera. In some embodiments, calculating distances between the points and the virtual camera can include calculating, in 3D space, linear distances between the points and the virtual cameras. In some embodiments, calculating distances between the points and the virtual camera can include comparing the metadata of the points to a pose of the virtual camera. In these embodiments, the metadata can include data describing the real cameras associated with the images that were used to triangulate the points, and specifically the poses of the real cameras.

At step 808, a 3D representation of a scene or a structure including points from the point cloud or the segmented point cloud, or line segments from the line cloud or the segmented line cloud, is generated or rendered from a perspective of the virtual camera. The perspective of the virtual camera can be defined by virtual camera extrinsics and intrinsics, such as, for example, a virtual camera pose, including position and orientation, a virtual camera field of view, a virtual camera viewing window, and the like. In some embodiments, the 3D representation is generated or rendered from the perspective of the virtual camera based on the virtual camera's relation to the real cameras, for example, based on the distances between the real cameras and the virtual camera (as calculated at step 806). In some embodiments, the 3D representation is generated or rendered from the perspective of the virtual camera based on the virtual camera's relation to the points, for example, based on the distances between the points and the virtual camera (as calculated at step 806). In some embodiments, generating or rendering the 3D representation from the perspective of the virtual camera includes calculating/associating a weight (e.g., opacity/transparency value) for each point, or line segment, based on the distances between the real cameras associated with the point, or line segment, and the virtual camera, and generating or rendering the 3D representation from the perspective of the virtual camera including the points, or line segments, based on the calculated/associated weights. In some embodiments, generating or rendering the 3D representation from the perspective of the virtual camera includes calculating/associating a weight (e.g., opacity/transparency value) for each point, or line segment, based on the distances between the points and the virtual camera, and generating or rendering the 3D representation from the perspective of the virtual camera including the points based on the calculated/associated weights. In some embodiments, generating or rendering the 3D representation from the perspective of the virtual camera includes, associating each point or line segment to at least one real camera, calculating/associating a weight for each point or line segment based on the distance between the real camera associated with the point, or line segment, and the virtual camera, and generating or rendering the 3D representation from the perspective of the virtual camera including the points, or the line segments, based on the calculated/associated weights. In some examples, the weight can be inversely related to the distance between the real camera and the virtual camera. That is to say, the smaller the distance between the real camera and the virtual camera, the higher the weight, and vice versa. In some examples, the weight can be inversely related to the distance between the point and the virtual camera. That is to say, the smaller the distance between the point and the virtual camera, the higher the weight, and vice versa. In some embodiments, a 2D representation of the 3D representation is generated from the perspective of the virtual camera.

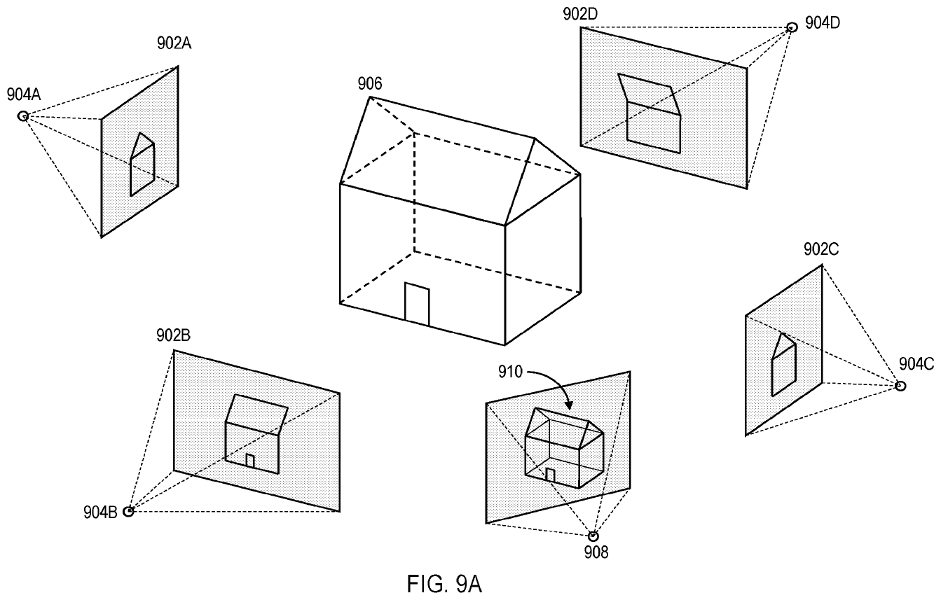

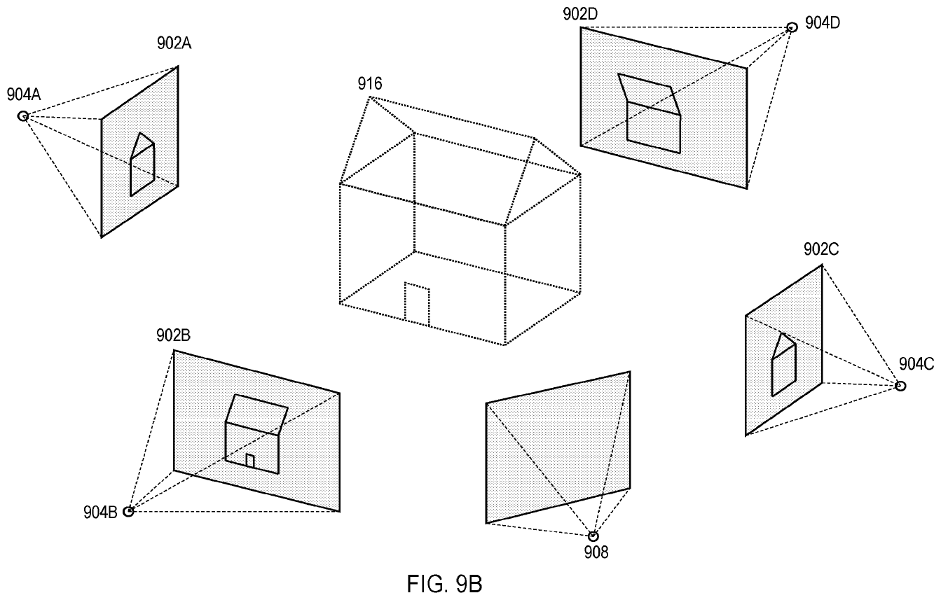

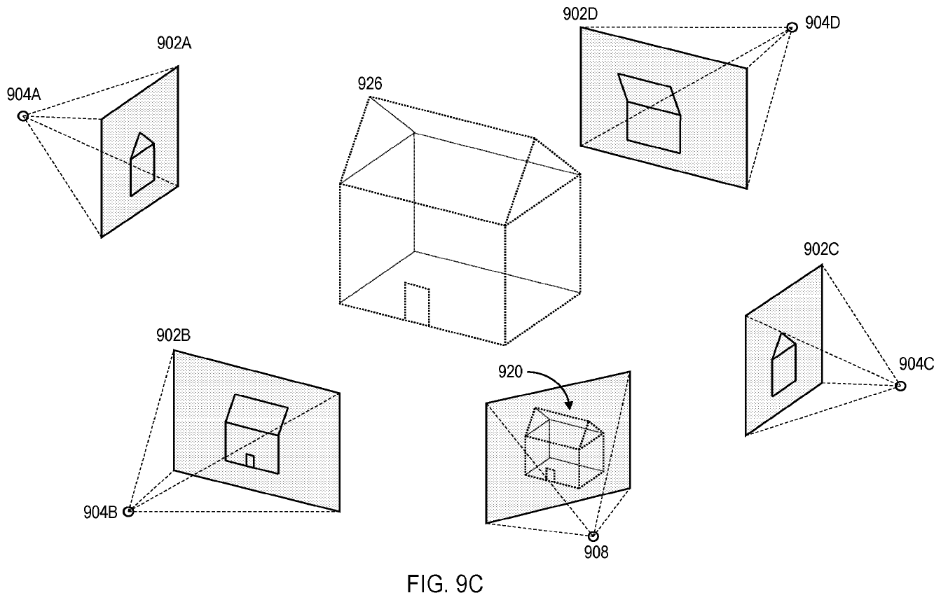

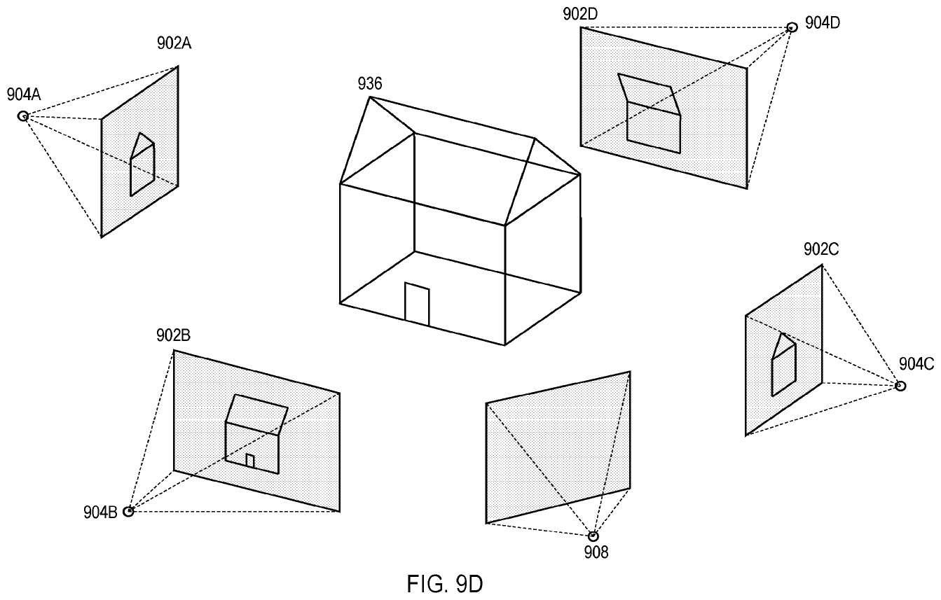

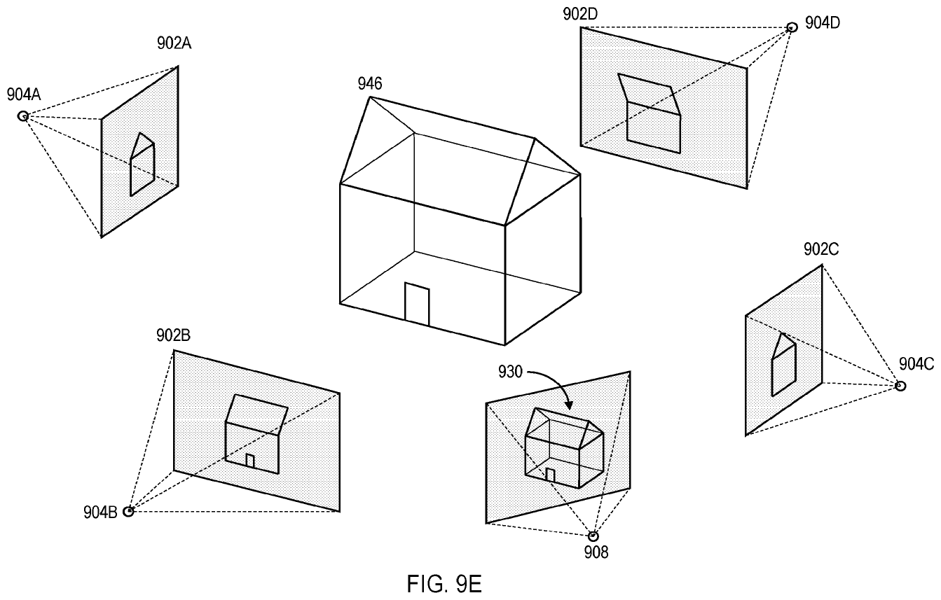

FIG. 9A illustrates a ground-level image capture, according to some embodiments. Images 902A-902D are received. The images 902A-902D can be captured by a data capture device, such as a smartphone or a tablet computer. In some embodiments, a point cloud is generated based on the images 902A-902D. FIG. 9B illustrates a point cloud 916 of the ground-level image capture including images 902A-902D, according to some embodiments. In this example, the point cloud 916 of FIG. 9B is an example 3D representation of subject structure 906 of FIG. 9A. In some embodiments, the point cloud is a line cloud. FIG. 9D illustrates a line cloud 936 of the ground-level image capture including images 902A-902D, according to some embodiments. In this example, the line cloud 936 of FIG. 9D is an example 3D representation of the subject structure 906 of FIG. 9A. In some embodiments, the point cloud 916, or the line cloud 936, can be segmented, for example, based on a subject of interest, such as the subject structure 906. In some embodiments, the images 902A-902D are segmented, for example, based on the subject structure 906, and the point cloud 916, or the line cloud 936, is generated based on the segmented images. Generating the point cloud 916 or the line cloud 936 includes calculating, for each image 902A-902D, poses for real cameras 904A-904D associated with the images 902A-902D, respectively. In some embodiments, generating the point cloud 916 or the line cloud 936 includes generating metadata for each point of the point cloud 916 or each end point of each line segment of the line cloud 936. In some embodiments, distances between the real cameras 904A-904D and a virtual camera 908 are calculated. In some embodiments, distances between points of the point cloud 916 or end points of line segments of the line cloud 936 and the virtual camera 908 are calculated.

A 3D representation of the subject structure 906 including points from the point cloud 916, or line segments from the line cloud 936, is generated or rendered from the perspective of the virtual camera 908, for example, based on the pose of the virtual camera 908 and the distances between the real cameras 904A-904D and the virtual camera 908, the distances between the points of the point cloud 916 or the end points of the line segments of the line cloud 936, or a combination thereof.

FIG. 9C illustrates a modified point cloud 926 (also referred to as “3D representation 926”), according to some embodiments. The modified point cloud 926 is a modified version of the point cloud 916. In some embodiments, for example as illustrated in FIG. 9C, generating or rendering the 3D representation 926 from the perspective of the virtual camera 908 includes calculating/associating a weight (e.g., opacity/transparency value) for each point based on the distance between the real camera 904A-904D associated with the point and the virtual camera 908, and generating or rendering the 3D representation 926 from the perspective of the virtual camera 908 including the points based on the calculated/associated weights. For example, the weight can be inversely related to the distance between the real camera 904A-904D and the virtual camera 908. In some embodiments, for example as illustrated in FIG. 9C, generating or rendering the 3D representation 926 from the perspective of the virtual camera 908 includes calculating/associating a weight (e.g., opacity/transparency value) for each point based on the distance between the point and the virtual camera 908, and generating or rendering the 3D representation 926 from the perspective of the virtual camera 908 including the points based on the calculated/associated weights. For example, the weight can be inversely related to the distance between the point and the virtual camera 908. As illustrated in FIG. 9C, the 3D representation 926 includes points that are illustrated in images 902A-902D. The points illustrated in the images 902B-902C that are in the 3D representation 926 have a higher weight (are more opaque) than the points illustrated in images 902A and 902D that are in the 3D representation 926 as the distance between the real cameras 904B and 904C, or the points of the point cloud 926 that were generated from the images 902B and 902C, and the virtual camera 908 is less than the distance between the real cameras 904A and 904D, or the points of the point cloud 926 that were generated from the images 902A and 902D, and the virtual camera 908. A 2D representation 920 of the 3D representation 926 is generated or rendered from the perspective of the virtual camera 908.

FIG. 9E illustrates a modified line cloud 946 (also referred to as “3D representation 946”), according to some embodiments. The modified line cloud 946 is a modified version of the line cloud 936. In some embodiments, for example as illustrated in FIG. 9E, generating or rendering the 3D representation 946 from the perspective of the virtual camera 908 includes calculating/associating a weight (e.g., opacity/transparency value) for each line segment based on the distance between the real camera 904A-904D associated with the line segment and the virtual camera 908, and generating or rendering the 3D representation 946 from the perspective of the virtual camera 908 including the line segments based on the associated weights. For example, the weight can be inversely related to the distance between the real camera 904A-904D and the virtual camera 908. In some embodiments, for example as illustrated in FIG. 9E, generating or rendering the 3D representation 946 from the perspective of the virtual camera 908 includes calculating/associating a weight (e.g., opacity/transparency value) for each end point of each line segment based on the distance between the end points of the line segment and the virtual camera 908, and generating or rendering the 3D representation 946 from the perspective of the virtual camera 908 including the end points of the line segments based on the associated weights. For example, the weight can be inversely related to the distance between the end points of the line segment and the virtual camera 908. As illustrated in FIG. 9E, the 3D representation 946 includes line segments that are illustrated in images 902A-902D. The line segments illustrated in the images 902B-902C that are in the 3D representation 946 have a higher weight (are more opaque) than the line segments illustrated in images 902A and 902D that are in the 3D representation 946 as the distance between the real cameras 904B and 904C, or the end points of the line segments of the line cloud 936 that were generated from the images 902B and 902C, and the virtual camera 908 is less than the distance between the real cameras 904A and 904D, or the end points of the line segments of the line cloud 936 that were generated from the images 902A and 902D, and the virtual camera 908. 2D representations 910 and 930 of the 3D representation 946 are generated or rendered from the perspective of the virtual camera 908.

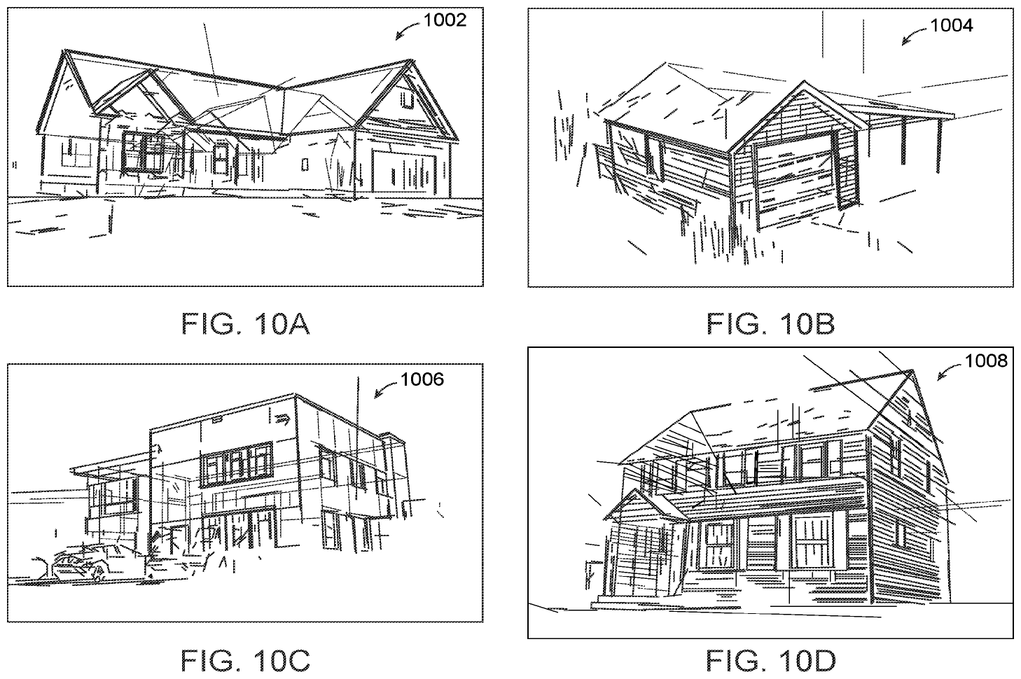

FIGS. 10A-10D illustrate experimental results of modified point cloud or line cloud rendering of 3D representations 1002-1008, respectively, according to some embodiments. The 3D representations 1002-1008 accurately represent a “see-through” version the spatial data for the subject buildings appearance and features according to a particular rendered camera (e.g., virtual camera) associated with each of the 3D representations 1002-1008. These serve as pose-dependent de-noised renderings of the subject structures, in that points and lines not likely to be visible from the virtual camera are modified (i.e., opacity adjusted).

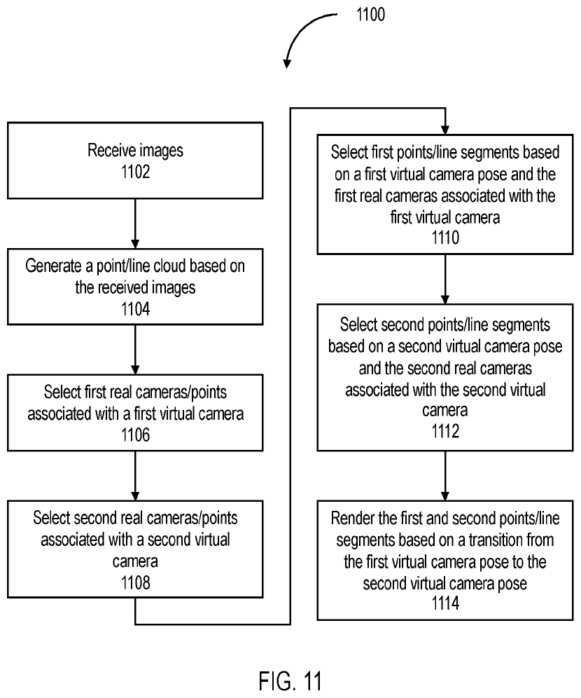

FIG. 11 illustrates a method 1100 for rendering points based on a transition from a first virtual camera pose to a second virtual camera pose, according to some embodiments. At step 1102, images are received. A data capture device, such as a smartphone or a tablet computer, can capture the images. Other examples of data capture devices include drones and aircraft. The images can include image data (e.g., color information) and/or depth data (e.g., depth information). The image data can be from an image sensor, such as a charge coupled device (CCD) sensor or a complementary metal-oxide-semiconductor (CMOS) sensor, embedded within the data capture device. The depth data can be from a depth sensor, such as a LiDAR sensor or a time-of-flight sensor, embedded within the data capture device.

At step 1104, a point cloud is generated based on the received images. A point cloud is a set of data points in a 3D coordinate system. The point cloud can represent co-visible points across the images. Generating the point cloud based on the received images can include implementing one or more techniques, such as, for example, a structure-from-motion (SfM) technique which utilizes 2D images (i.e., the image data of the images) to construct a 3D structure (i.e., the point cloud). In some embodiments, the point cloud is a line cloud. A line cloud is a set of data line segments in a 3D coordinate system. The line cloud can represent co-visible line segments across the images. Generating the line cloud based on the received images can include implementing one or more techniques that utilizes the 2D images (i.e., the image data of the images) to construct a 3D structure (i.e., the line cloud). In some embodiments, 2D line segments in the 2D images can be derived from 2D points of the 2D images using one or more techniques, such as, for example, Hough transformations, edge detection, feature detection, contour detection, curve detection, random sample consensus (RANSAC), and the like. The derived 2D line segments can be triangulated to construct the line cloud. In some embodiments, 3D points of the point cloud that correspond to the 2D points of the 2D line segments (e.g., end points of the 2D line segments) can be connected in 3D to form a 3D line segment. In some embodiments, 3D line segments can be derived from 3D points of the point cloud, for example based on relative locations of the 3D points. In some embodiments, the point cloud, or the line cloud, can be segmented, for example, based on a subject of interest, such as a structure. In some embodiments, the received images are segmented, for example, based on a subject of interest, such as a structure, and the point cloud, or the line cloud, is generated based on the segmented images. Generating the point cloud or the line cloud includes calculating, for each image, a pose of a real camera associated with the image. The pose of the real camera can include position data and orientation data associated with the real camera.

In some embodiments, generating the point cloud can include generating metadata for each point of the point cloud or for each end point of each line segment of the line cloud. The metadata can be derived from the images that were used to triangulate the point. In some examples, the metadata can include data describing real cameras associated with the images that were used to triangulate the point. For example, metadata including data describing real cameras associated with the images can include real camera extrinsics and intrinsics, such as, for example, a real camera pose, including position and orientation in a coordinate space of the point cloud or the line cloud, a real camera field of view, a real camera viewing window, and the like. In some examples, the metadata can include data describing the images that were used to triangulate the point. In these examples, the metadata can include capture times of the images. In some examples, the metadata can include data describing specific pixels of the images that were used to triangulate the point. In these examples, the metadata can include color values (e.g., red-, green-, and blue-values) of the specific pixels, semantic labels (e.g., structure, not structure, etc.) of the specific pixels, and the like. In some examples, the metadata can include a visibility value. The visibility value can be generated based on the 3D angles between the point and optical centers of real cameras associated with the images that were used to triangulate the point. The visibility value and the 3D position of the point can be used to define a pose of the point.

In some embodiments, for example between steps 1104 and 1106, or as a part of step 1106, a first selected virtual camera is received. The first virtual camera can include, for example, first virtual camera extrinsics and intrinsics, such as, for example, a first virtual camera pose, including position and orientation in a coordinate space of the point cloud or the line cloud generated in step 1104, a first virtual camera field of view, a first virtual camera viewing window, and the like. In some embodiments, a first virtual camera is selected at an arbitrary location relative to the point cloud or the line cloud; in some embodiments, a first virtual camera is selected within a spatial constraint. The spatial constraint can impose restrictions on the pose of the first virtual camera. In some embodiments, the spatial constraint is such that a frustum of the first virtual camera shares at least ten percent of the field of view of two real cameras associated with the point cloud or the line cloud.

In some embodiments, at step 1106, first real cameras associated with a first selected virtual camera are selected. The real cameras associated with the first virtual camera can include a subset of all the real cameras. In some embodiments, selecting the first real cameras associated with the first virtual camera can include comparing the poses of the real cameras to a pose of the first virtual camera. The pose of the first virtual camera can include position data and orientation data associated with the first virtual camera. In some embodiments, comparing the poses of the real cameras to the pose of the first virtual camera includes comparing 3D positions of the real cameras to a position of the first virtual camera. In some embodiments, if a distance between the position of the first virtual camera and the position of a real camera is less than or equal to a threshold distance value, the real camera can be considered associated with the first virtual camera. In one example, the threshold distance value can be a predetermined distance value, where the predetermined distance value can be in modeling space units, render space units, or real-world units such as five meters. In this example, all points including metadata describing the real cameras that are within the predetermined distance value of the first virtual camera are selected (i.e., considered to be associated with the first virtual camera). In this example, the threshold distance value is an absolute value (i.e., absolute distance). In some examples the threshold distance is an angular relationship, such as an azimuth of a real camera as measured from the optical axis of a real camera compared the azimuth of the first virtual camera. A real camera with an azimuth within ninety degrees of the first virtual camera may be eligible for selection, and the points associated with such selected real camera are selectively rendered. In some examples, a threshold distance value satisfies both a predetermined distance value and an angular relationship.

In some embodiments, selecting first real cameras associated with the first virtual camera can include selecting real cameras that are the k-nearest neighbors of the first virtual camera, for example by performing a k-nearest neighbors search. In these embodiments, k can be an absolute value (e.g., eight) or a relative value (e.g., relative to the total number of real cameras, relative to the number of real cameras within a threshold distance of the first virtual camera, relative to distances between the real cameras and the first virtual camera, relative to a frustrum of the first virtual camera, etc.).

In some embodiments, selecting the first real cameras associated with the first virtual camera can include comparing fields of view of the real cameras with a field of view, or a view frustum, of the first virtual camera. In some embodiments, if a field of view of a real camera overlaps a field of view of the first virtual camera, the real camera is considered associated with the first virtual camera. In some embodiments, if a field of view of real camera shares at least a threshold of a field of view of the first virtual camera, the field of view of the real camera is considered to overlap the field of view of the first virtual camera. Examples of thresholds include five percent, ten percent, fifteen percent, and the like.

In some embodiments, selecting the first real cameras associated with the first virtual camera can include comparing capture times, or timestamps, associated with the real cameras. A capture time, or timestamp, associated with a real camera can represent a time the real camera captured an associated image. In some embodiments, if several real cameras are associated with the first virtual camera, for example by comparing the poses of the real cameras to the pose of the first virtual camera, by comparing the fields of views of the real cameras to the field of view of the first virtual camera, or both, capture times associated with the several real cameras associated with the first virtual camera can be compared to one another, and real cameras whose associated capture times are temporally proximate to one another or temporally proximate to one of the several real cameras can be associated with the first virtual camera. In some embodiments, the temporal proximity can be relative to an absolute value (i.e., absolute time) or a relative value (e.g., relative to capture times, or multiples thereof, associated with all of the real cameras or a subset of the real cameras (i.e., the several real cameras)). Examples of absolute values include thirty seconds, sixty seconds, ninety seconds, and the like. In some examples, a relative value of ten percent of a total capture time defines real cameras that are temporally proximate. The first virtual camera can be placed relative to a point cloud, and in some examples a real camera geometrically close to the first virtual camera (e.g., by threshold value discussed elsewhere) is identified, and other real cameras captured within the relative timestamp of the geometrically close real camera are selected. In some embodiments, the first virtual camera can be placed according to a time stamp, and the real cameras within a relative value are selected.

In some embodiments, selecting the first real cameras associated with the first virtual camera can include comparing the poses of the real cameras to the pose of the first virtual camera, comparing the fields of views of the real cameras to the field of view of the first virtual camera, comparing the capture times associated with the real cameras, or some combination thereof.

In some embodiments, at step 1106, real cameras are associated with a first selected virtual camera. In some embodiments, associating the real cameras with the first virtual camera can include comparing poses of the real cameras to a pose of the first virtual camera, comparing fields of view of the real cameras to a field of view of the first virtual camera, comparing capture times associated with the real cameras, or some combination thereof.

In some embodiments, at step 1106, points of the point cloud or end points of line segments of the line cloud associated with the first selected virtual camera are selected. The points associated with the first selected virtual camera can include a subset of all the points of the point cloud or all the end points of the line segments of the line cloud. In some embodiments, selecting points associated with the first virtual camera can include selecting the points based on metadata associated with the points.

In some examples, selecting the points based on the metadata can include comparing data describing real cameras associated with the images that were used to triangulate the points to data describing the first virtual camera. This can include, for example, comparing real camera extrinsics and intrinsics, comparing poses of the real cameras to a pose of the first virtual camera, comparing fields of view of the real cameras to a field of view of the first virtual camera, or a combination thereof.

In some embodiments, if a distance between the position of the first virtual camera and the position of a real camera is less than or equal to a threshold distance value, points including metadata describing the real camera are selected (i.e., considered to be associated with the first virtual camera). In one example, the threshold distance value can be a predetermined distance value, where the predetermined distance value can be in modeling space units, render space units, or real-world units such as five meters. In this example, all points including metadata describing the real cameras that are within the predetermined distance value of the first virtual camera are selected (i.e., considered to be associated with the first virtual camera). In this example, the threshold distance value is an absolute value (i.e., absolute distance). In some examples the threshold distance is an angular relationship, such as an azimuth of a real camera as measured from the optical axis of a real camera compared the azimuth of the first virtual camera. A real camera with an azimuth within ninety degrees of the first virtual camera may be eligible for selection, and the points associated with such selected real camera are selectively rendered. In some examples, a threshold distance value satisfies both a predetermined distance value and an angular relationship.

In some embodiments, points including metadata describing the real cameras that are the k-nearest neighbors of the first virtual camera, for example by performing a k-nearest neighbors search, are selected (i.e., considered to be associated with the first virtual camera). In these embodiments, k can be an absolute value (e.g., eight) or a relative value (e.g., relative to the total number of real cameras, relative to the number of real cameras within a threshold distance of the first virtual camera, relative to distances between the real cameras and the first virtual camera, relative to a frustrum of the first virtual camera, etc.).

In some embodiments, if a field of view of the first virtual camera overlaps a field of view of a real camera, points including metadata describing the real camera are selected (i.e., considered to be associated with the first virtual camera).

In some examples, selecting the points based on the metadata associated with the points can include comparing data describing the images, or the real cameras associated with the images, that were used to triangulate the points to one another. This can include, for example, comparing capture times associated with the images, or the real cameras associated with the images.

In some embodiments, if several points are selected (i.e., associated with the first virtual camera), for example by comparing the poses of the real cameras to the pose of the first virtual camera, by comparing the fields of views of the real cameras to the field of view of the first virtual camera, or both, capture times associated with the images, or the real cameras associated with the images, associated with the several points can be compared to one another. Points associated with images, or real cameras associated with images, whose associated capture times are temporally proximate to one another or temporally proximate to one of the images, or the real cameras associated with the images, associated with the several points can be selected (i.e., considered to be associated with the first virtual camera). In some embodiments, the temporal proximity can be relative to an absolute value (i.e., absolute time) or a relative value (e.g., relative to capture times, or multiples thereof, associated with all the real cameras or a subset of the real camera (i.e., the real cameras associated with the several points)). Examples of absolute values include thirty seconds, sixty seconds, ninety seconds, and the like. In some examples, a relative value of ten percent of a total capture time defines real cameras that are temporally proximate. The first virtual camera can be placed relative to a point cloud, and in some examples a real camera geometrically close to the first virtual camera (e.g., by threshold value discussed elsewhere) is identified, and other real cameras captured within the relative timestamp of the geometrically close real camera are selected. In some embodiments, the first virtual camera can be placed according to a time stamp, and the real cameras within a relative value are selected.

In some examples, selecting the points based on the metadata associated with the points can include comparing data describing specific pixels of the images that were used to triangulate the points to one another, to a set of values/labels, or a combination thereof. This can include, for example, comparing color values to one another or to a set of color values, or comparing semantic labels to one another or to a set of semantic labels, or a combination thereof.

In some embodiments, color values are compared to one another or to a set of color values, for example that are commonly associated with a structure. In some embodiments, if color values of adjacent points are similar to one another or if color values of points are similar to a set of color values that are commonly associated with a structure, points including metadata describing the color values can be selected (i.e., considered to be associated with the first virtual camera). In some embodiments, if a semantic label of the point is associated with a structure, the point including metadata describing the semantic label is selected (i.e., considered to be associated with the first virtual camera).

In some examples, selecting the points based on the metadata can include comparing visibility values to one another, to the first virtual camera, or a combination thereof.

In some embodiments, a virtual camera can be matched to a first real camera and a second real camera. The first real camera can observe a first point, a second point, and a third point, and the second real camera can observe the second point, the third point, and a fourth point. The points that satisfy a visibility value for both the first real camera and the second real camera can be selected. In other words, the points that are observed by both the first real camera and the second real camera can be selected. In this example, the second point and the third point satisfy the visibility value for both the first real camera and the second real camera.

In some embodiments, a viewing frustum of a virtual camera can include first through seventh points. A first real camera can observe the first through third points, a second real camera can observe the second through fourth points, and a third camera can observe the fifth through seventh points. The points that have common visibility values can be selected. In other words, the points that are observed by several real cameras can be selected. In this example, the second point and the third point satisfy the visibility value for both the first real camera and the second real.

In some embodiments, at step 1106, points of the point cloud or end points of line segments of the line cloud are associated with the first virtual camera. In some embodiments, associating the points can include selecting the points based on metadata associated with the points.

In some embodiments, for example between steps 1106 and 1108, or as a part of step 1108, a second selected virtual camera is received. The second virtual camera can include, for example, second virtual camera extrinsics and intrinsics, such as, for example, a second virtual camera pose, including position and orientation in a coordinate space of the point cloud or the line cloud generated in step 1104, a second virtual camera field of view, a second virtual camera viewing window, and the like. In some embodiments, a second virtual camera is selected at an arbitrary location relative to the point cloud or the line cloud; in some embodiments, a second virtual camera is selected within a spatial constraint. The spatial constraint can impose restrictions on the pose of the second virtual camera. In some embodiments, the spatial constraint is such that a frustum of the second virtual camera shares at least ten percent of the field of view of two real cameras associated with the point cloud or the line cloud.

In some embodiments, at step 1108, second real cameras associated with a second selected virtual camera are selected. The real cameras associated with the second virtual camera can include a subset of all the real cameras. In some embodiments, selecting the second real cameras associated with the second virtual camera can include comparing the poses of the real cameras to a pose of the second virtual camera. The pose of the second virtual camera can include position data and orientation data associated with the second virtual camera. In some embodiments, comparing the poses of the real cameras to the pose of the second virtual camera includes comparing 3D positions of the real cameras to a position of the second virtual camera. In some embodiments, if a distance between the position of the second virtual camera and the position of a real camera is less than or equal to a threshold distance value, the real camera can be considered associated with the second virtual camera. In one example, the threshold distance value can be a predetermined distance value, where the predetermined distance value can be in modeling space units, render space units, or real-world units such as five meters. In this example, all points including metadata describing the real cameras that are within the predetermined distance value of the second virtual camera are selected (i.e., considered to be associated with the second virtual camera). In this example, the threshold distance value is an absolute value (i.e., absolute distance). In some examples the threshold distance is an angular relationship, such as an azimuth of a real camera as measured from the optical axis of a real camera compared the azimuth of the second virtual camera. A real camera with an azimuth within ninety degrees of the second virtual camera may be eligible for selection, and the points associated with such selected real camera are selectively rendered. In some examples, a threshold distance value satisfies both a predetermined distance value and an angular relationship.

In some embodiments, selecting second real cameras associated with the second virtual camera can include selecting real cameras that are the k-nearest neighbors of the second virtual camera, for example by performing a k-nearest neighbors search. In these embodiments, k can be an absolute value (e.g., eight) or a relative value (e.g., relative to the total number of real cameras, relative to the number of real cameras within a threshold distance of the second virtual camera, relative to distances between the real cameras and the second virtual camera, relative to a frustrum of the second virtual camera, etc.).

In some embodiments, selecting the second real cameras associated with the second virtual camera can include comparing fields of view of the real cameras with a field of view, or a view frustum, of the second virtual camera. In some embodiments, if a field of view of a real camera overlaps a field of view of the second virtual camera, the real camera is considered to be associated with the second virtual camera. In some embodiments, if a field of view of real camera shares at least a threshold of a field of view of the second virtual camera, the field of view of the real camera is considered to overlap the field of view of the second virtual camera. Examples of thresholds include five percent, ten percent, fifteen percent, and the like.

In some embodiments, selecting the second real cameras associated with the second virtual camera can include comparing capture times, or timestamps, associated with the real cameras. A capture time, or timestamp, associated with a real camera can represent a time the real camera captured an associated image. In some embodiments, if several real cameras are associated with the second virtual camera, for example by comparing the poses of the real cameras to the pose of the second virtual camera, by comparing the fields of views of the real cameras to the field of view of the second virtual camera, or both, capture times associated with the several real cameras associated with the second virtual camera can be compared to one another, and real cameras whose associated capture times are temporally proximate to one another or temporally proximate to one of the several real cameras can be associated with the second virtual camera. In some embodiments, the temporal proximity can be relative to an absolute value (i.e., absolute time) or a relative value (e.g., relative to capture times, or multiples thereof, associated with all of the real cameras or a subset of the real cameras (i.e., the several real cameras)). Examples of absolute values include thirty seconds, sixty seconds, ninety seconds, and the like. In some examples, a relative value of ten percent of a total capture time defines real cameras that are temporally proximate. The second virtual camera can be placed relative to a point cloud, and in some examples a real camera geometrically close to the second virtual camera (e.g., by threshold value discussed elsewhere) is identified, and other real cameras captured within the relative timestamp of the geometrically close real camera are selected. In some embodiments, the second virtual camera can be placed according to a time stamp, and the real cameras within a relative value are selected.

In some embodiments, selecting the second real cameras associated with the second virtual camera can include comparing the poses of the real cameras to the pose of the second virtual camera, comparing the fields of views of the real cameras to the field of view of the second virtual camera, comparing the capture times associated with the real cameras, or some combination thereof.

In some embodiments, at step 1108, real cameras are associated with a second selected virtual camera. In some embodiments, associating the real cameras with the second virtual camera can include comparing poses of the real cameras to a pose of the second virtual camera, comparing fields of view of the real cameras to a field of view of the second virtual camera, comparing capture times associated with the real cameras, or some combination thereof.

In some embodiments, at step 1108, points of the point cloud or end points of line segments of the line cloud associated with the second selected virtual camera are selected. The points associated with the second selected virtual camera can include a subset of all the points of the point cloud or all the end points of the line segments of the line cloud. In some embodiments, selecting points associated with the second virtual camera can include selecting the points based on metadata associated with the points.

In some examples, selecting the points based on the metadata can include comparing data describing real cameras associated with the images that were used to triangulate the points to data describing the second virtual camera. This can include, for example, comparing real camera extrinsics and intrinsics, comparing poses of the real cameras to a pose of the second virtual camera, comparing fields of view of the real cameras to a field of view of the second virtual camera, or a combination thereof.

In some embodiments, if a distance between the position of the second virtual camera and the position of a real camera is less than or equal to a threshold distance value, points including metadata describing the real camera are selected (i.e., considered to be associated with the second virtual camera). In one example, the threshold distance value can be a predetermined distance value, where the predetermined distance value can be in modeling space units, render space units, or real-world units such as five meters. In this example, all points including metadata describing the real cameras that are within the predetermined distance value of the second virtual camera are selected (i.e., considered to be associated with the second virtual camera). In this example, the threshold distance value is an absolute value (i.e., absolute distance). In some examples the threshold distance is an angular relationship, such as an azimuth of a real camera as measured from the optical axis of a real camera compared the azimuth of the second virtual camera. A real camera with an azimuth within ninety degrees of the second virtual camera may be eligible for selection, and the points associated with such selected real camera are selectively rendered. In some examples, a threshold distance value satisfies both a predetermined distance value and an angular relationship.

In some embodiments, points including metadata describing the real cameras that are the k-nearest neighbors of the second virtual camera, for example by performing a k-nearest neighbors search, are selected (i.e., considered to be associated with the second virtual camera). In these embodiments, k can be an absolute value (e.g., eight) or a relative value (e.g., relative to the total number of real cameras, relative to the number of real cameras within a threshold distance of the second virtual camera, relative to distances between the real cameras and the second virtual camera, relative to a frustrum of the second virtual camera, etc.).

In some embodiments, if a field of view of the second virtual camera overlaps a field of view of a real camera, points including metadata describing the real camera are selected (i.e., considered to be associated with the second virtual camera).

In some examples, selecting the points based on the metadata associated with the points can include comparing data describing the images, or the real cameras associated with the images, that were used to triangulate the points to one another. This can include, for example, comparing capture times associated with the images, or the real cameras associated with the images.

In some embodiments, if several points are selected (i.e., associated with the second virtual camera), for example by comparing the poses of the real cameras to the pose of the second virtual camera, by comparing the fields of views of the real cameras to the field of view of the second virtual camera, or both, capture times associated with the images, or the real cameras associated with the images, associated with the several points can be compared to one another. Points associated with images, or real cameras associated with images, whose associated capture times are temporally proximate to one another or temporally proximate to one of the images, or the real cameras associated with the images, associated with the several points can be selected (i.e., considered to be associated with the second virtual camera). In some embodiments, the temporal proximity can be relative to an absolute value (i.e., absolute time) or a relative value (e.g., relative to capture times associated with all the real cameras or a subset of the real camera (i.e., the real cameras associated with the several points)). Examples of absolute values include thirty seconds, sixty seconds, ninety seconds, and the like. In some examples, a relative value of ten percent of a total capture time defines real cameras that are temporally proximate. The second virtual camera can be placed relative to a point cloud, and in some examples a real camera geometrically close to the second virtual camera (e.g., by threshold value discussed elsewhere) is identified, and other real cameras captured within the relative timestamp of the geometrically close real camera are selected. In some embodiments, the second virtual camera can be placed according to a time stamp, and the real cameras within a relative value are selected.

In some examples, selecting the points based on the metadata associated with the points can include comparing data describing specific pixels of the images that were used to triangulate the points to one another, to a set of values/labels, or a combination thereof. This can include, for example, comparing color values to one another or to a set of color values, or comparing semantic labels to one another or to a set of semantic labels, or a combination thereof.

In some embodiments, color values are compared to one another or to a set of color values, for example that are commonly associated with a structure. In some embodiments, if color values of adjacent points are similar to one another or if color values of points are similar to a set of color values that are commonly associated with a structure, points including metadata describing the color values can be selected (i.e., considered to be associated with the second virtual camera). In some embodiments, if a semantic label of the point is associated with a structure, the point including metadata describing the semantic label is selected (i.e., considered to be associated with the second virtual camera).

In some examples, selecting the points based on the metadata can include comparing visibility values to one another, to the second virtual camera, or a combination thereof.

In some embodiments, a virtual camera can be matched to a first real camera and a second real camera. The first real camera can observe a first point, a second point, and a third point, and the second real camera can observe the second point, the third point, and a fourth point. The points that satisfy a visibility value for both the first real camera and the second real camera can be selected. In other words, the points that are observed by both the first real camera and the second real camera can be selected. In this example, the second point and the third point satisfy the visibility value for both the first real camera and the second real camera.

In some embodiments, a viewing frustum of a virtual camera can include first through seventh points. A first real camera can observe the first through third points, a second real camera can observe the second through fourth points, and a third camera can observe the fifth through seventh points. The points that have common visibility values can be selected. In other words, the points that are observed by several real cameras can be selected. In this example, the second point and the third point satisfy the visibility value for both the first real camera and the second real camera.

In some embodiments, at step 1108, points of the point cloud or end points of line segments of the line cloud are associated with the second virtual camera. In some embodiments, associating the points can include selecting the points based on metadata associated with the points.

At step 1110, first points, or first line segments, are selected based on a first relation of the first virtual camera and the first real cameras associated with the first virtual camera. For example, the first points, or the first line segments, are selected based on the pose of the first virtual camera and the poses of the first real cameras associated with the first virtual camera. In some embodiments, selecting the first points, or the first line segments, includes selecting points of the point cloud or the segmented point cloud, or line segments of the line cloud or the segmented line cloud, that are associated with the first real cameras associated with the first virtual camera. In some embodiments, selecting the first points, or the first line segments, includes selecting points of the point cloud or the segmented point cloud, or line segments of the line cloud or the segmented line cloud, that originated from images captured by the first real cameras associated with the first virtual camera. In some embodiments, selecting the first points, or the first line segments, includes selecting points of the point cloud or the segmented point cloud, or line segments of the line cloud or the segmented line cloud, that are visible or observed by the first real cameras associated with the first virtual camera. In some embodiments, the first points, or first line segments, are selected from the perspective of the first virtual camera. The selected points, or selected line segments, are referred to as the first points, or the first line segments. In some examples, each point of the point cloud or the segmented point cloud or each line segment of the line cloud or the segmented line cloud can include metadata that references which one or more images the point or line segment originated from. In some examples, selecting the first points or first line segments that originated from or are visible or observed by images captured by the first real cameras associated with the first virtual camera can include reprojecting the points or the line segments into the images captured by the first real cameras associated with the first virtual camera, and selecting the reprojected points or line segments.

At step 1112, second points, or second line segments, are selected based on a second relation of the second virtual camera and the second real cameras associated with the second virtual camera. For example, the second points, or the second line segments, are selected based on the pose of the second virtual camera and the poses of the second real cameras associated with the second virtual camera. In some embodiments, selecting the second points, or the second line segments, includes selecting points of the point cloud or the segmented point cloud, or line segments of the line cloud or the segmented line cloud, that are associated with the second real cameras associated with the second virtual camera. In some embodiments, selecting the second points, or the second line segments, includes selecting points of the point cloud or the segmented point cloud, or line segments of the line cloud or the segmented line cloud, that originated from images captured by the second real cameras associated with the second virtual camera. In some embodiments, selecting the second points, or the second line segments, includes selecting points of the point cloud or the segmented point cloud, or line segments of the line cloud or the segmented line cloud, that are visible or observed by the second real cameras associated with the second virtual camera. In some embodiments, the second points, or second line segments, are selected from the perspective of the second virtual camera. The selected points, or selected line segments, are referred to as the second points, or the second line segments. In some examples, each point of the point cloud or the segmented point cloud or each line segment of the line cloud or the segmented line cloud can include metadata that references which one or more images the point or line segment originated from. In some examples, selecting the second points or second line segments that originated from or are visible or observed by images captured by the second real cameras associated with the second virtual camera can include reprojecting the points or the line segments into the images captured by the second real cameras associated with the second virtual camera, and selecting the reprojected points or line segments.

At step 1114, the first points, or the first line segments, or subsets thereof, or the second points, or the second line segments, or subsets thereof, are rendered from the perspective of the first virtual camera, from the perspective of the second virtual camera, or from a perspective therebetween, for example, based on a transition from the first virtual camera to the second virtual camera. For example, the first points, or the first line segments, or subsets thereof, or the second points, or the second line segments, or subsets thereof, are rendered based on a transition from the pose of the first virtual camera to the pose of the second virtual camera. In some embodiments, the first points, or the first line segments, or subsets thereof, or the second points, or the second line segments, or subsets thereof, are rendered from a perspective of a virtual camera as the virtual camera transitions from the first virtual camera to the second virtual camera.

In some embodiments, step 1114 can include generating the transition from the first virtual camera to the second virtual camera, for example, by interpolating between the pose of the first virtual camera and the pose of the second virtual camera. The interpolation between the pose of the first virtual camera and the pose of the second virtual camera can be at least in part on the first real cameras associated with the first virtual camera, the second real cameras associated with the second virtual camera, or a combination thereof. In these embodiments, rendering the first points, or the first line segments, or subsets there, or the second points, or the second line segments, or subsets thereof can include rendering the first points, or the first line segments, or subsets there, or the second points, or the second line segments, or subsets thereof for various poses of the interpolation, for example the pose of the first virtual camera, the pose of the second virtual camera, and at least one pose therebetween.

In some embodiments, step 1114 includes generating or rendering color values for the first points, or the first line segments, or subsets thereof, or the second points, or the second line segments, or subsets thereof. A color value for a point can be generated based on the metadata associated with the points from the point cloud or the segmented point cloud, or end points of line segments of the line cloud or the segmented line cloud. As disclosed herein, each point of the point cloud or the segmented point cloud, and each end point of each line segment of the line cloud or the segmented line cloud includes metadata, and the metadata can include color values (e.g., red-, green-, blue-values) of the specific pixels of the images that were used to triangulate the point. Referring briefly to point cloud generation, each point is generated from at least a first pixel in a first image and a second pixel in a second image, though additional pixels from additional images can be used as well. The first pixel has a first color value and the second pixel has a second color value. The color value for the point can be generated by selecting a predominant color value of the first color value and the second color value, by calculating an average color value of the first color value and the second color value, and the like. In some embodiments, the predominant color value is the color value of the pixel of the image whose associated real camera is closest to the virtual cameras, which can be selected by comparing distances between the virtual camera and the real cameras associated with the images.

In some embodiments, steps 1110 and 1112 are optional, for example where at step 1106 points of the point cloud or end points of line segments of the line cloud are associated with the first virtual camera are selected and where at step 1108 points of the point cloud and end points of line segments of the line cloud are associated with the second virtual camera are selected. In the embodiments where steps 1110 and 1112 are optional, step 1114 can include rendering the points of the point cloud or end points of line segments of the line cloud that are associated with the first virtual camera and the points of the point cloud or end points of line segments of the line cloud that are associated with the second virtual camera based on a transition of the first virtual camera pose to the second virtual camera pose.

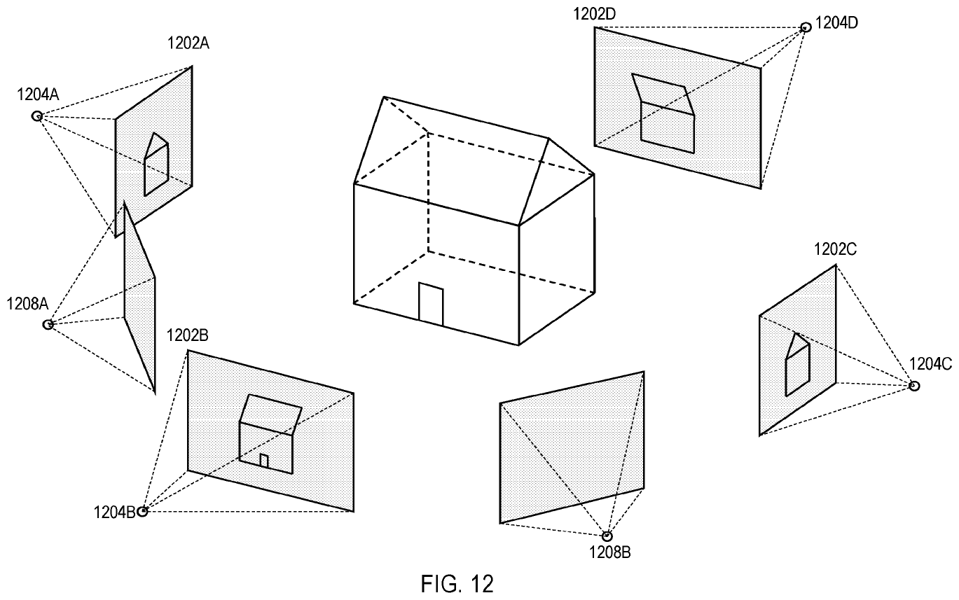

FIG. 12 illustrates a ground-level image capture and transitioning virtual cameras, according to some embodiments. Images 1202A-1202D are received. The images 1202A-1202D can be captured by a data capture device, such as a smartphone or a tablet computer. A point cloud (not shown) is generated based on the images 1202A-1402D. In some embodiments, the point cloud is a line cloud. In some embodiments, generating the point cloud or the line cloud includes generating metadata for each point of the point cloud or each end point of each line segment of the line cloud. In some embodiments, generating the point cloud includes calculating, for each image 1202A-1202D, poses for real cameras 1204A-1204D associated with the images 1202A-1204D, respectively.

In some embodiments, the real cameras 1204A-1204D associated with a first virtual camera 1208A are selected. For example, the real cameras 1204A-1204D associated with the first virtual camera 1208A are selected by comparing the poses of the real cameras 1204A-1204D and a pose of the first virtual camera 1208A, by comparing fields of view of the real cameras 1204A-1204D and a field of view of the first virtual camera 1208A, by comparing capture times associated with the images 1202A-1202D, or some combination thereof. In some embodiments, the real cameras 1204A-1204D are associated with the first virtual camera 1208A by comparing the poses of the real cameras 1204A-1204D and a pose of the first virtual camera 1208A, by comparing the fields of view of the real cameras 1204A-1204D and a field of view of the first virtual camera 1208A, by comparing capture times associated with the images 1202A-1202D, or some combination thereof. In the example illustrated in FIG. 12, the real cameras 1204A and 1204B are considered to be associated with, or are associated with, the first virtual camera 1208A. In some embodiments, points of the point cloud or end points of line segments of the line cloud associated with the first virtual camera 1208A are selected. For example, the points of the point cloud or the end points of the line segments of the line cloud are associated with the first virtual camera 1208A by selecting points based on metadata associated with the points.

The real cameras 1204A-1204D associated with a second virtual camera 1408B are selected. For example, the real cameras 1204A-1204D associated with the second virtual camera 1208B are selected by comparing the poses of the real cameras 1204A-1204D and a pose of the second virtual camera 1208B, by comparing fields of view of the real cameras 1204A-1204D and a field of view of the second virtual camera 1208B, by comparing capture times associated with the images 1202A-1202D, or some combination thereof. In some embodiments, the real cameras 1204A-1204D are associated with the second virtual camera 1208B by comparing the poses of the real cameras 1204A-1204D and a pose of the second virtual camera 1208B, by comparing the fields of view of the real cameras 1204A-1204D and a field of view of the second virtual camera 1208B, by comparing capture times associated with the images 1202A-1202D, or some combination thereof. In the example illustrated in FIG. 12, the real cameras 1204B and 1204C are considered to be associated with, or are associated with, the second virtual camera 1208B. In some embodiments, points of the point cloud or end points of line segments of the line cloud associated with the second virtual camera 1208B are selected. For example, the points of the point cloud or the end points of the line segments of the line cloud are associated with the first virtual camera 1208B by selecting points based on metadata associated with the points.

First points, or first line segments, are selected based on the pose of the first virtual camera 1208A and the real cameras 1204A and 1204B associated with the first virtual camera 1208A. In some embodiments, this is optional. In some embodiments, the first points, or the first line segments, are selected based on points of the point cloud, or line segments of the line cloud, that originated from the images 1202A and 1202B captured by the real cameras 1204A and 1204B associated with the first virtual camera 1208A. Second points, or second line segments, are selected based on the pose of the second virtual camera 1208B and the real cameras 1204B and 1204C associated with the second virtual camera 1208B. In some embodiments, this is optional. In some embodiments, the second points, or the second line segments, are selected based on points of the point cloud, or line segments of the line cloud, that originated from the images 1202B and 1202C captured by the real cameras 1204B and 1204C associated with the second virtual camera 1208B. The first and second points, or the first and second line segments, are rendered based on a transition from the pose of the first virtual camera 1208A to the pose of the second virtual camera 1208B. In some embodiments, the transition from the pose of the first virtual camera 1208A to the pose of the second virtual camera 1208B is generated, for example by interpolating between the pose of the first virtual camera 1208A and the pose of the second virtual camera 1208B.

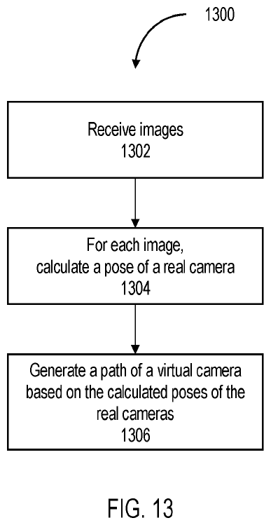

FIG. 13 illustrates a method 1300 for generating a path of a virtual camera, according to some embodiments. At step 1302, images are received. A data capture device, such as a smartphone or a tablet computer, can capture the images. Other examples of data capture devices include drones and aircraft. The images can include image data (e.g., color information) and/or depth data (e.g., depth information). The image data can be from an image sensor, such as a charge coupled device (CCD) sensor or a complementary metal-oxide-semiconductor (CMOS) sensor, embedded within the data capture device. The depth data can be from a depth sensor, such as a LiDAR sensor or a time-of-flight sensor, embedded within the data capture device. At step 1304, for each image, a pose of a real camera associated with the image is calculated. The pose of the real camera can include position data and orientation data associated with the real camera.

At step 1306, a path of a virtual camera is generated based on the poses of the real cameras. In some embodiments, the path of the virtual camera is generated based on a linear interpolation of the poses of the real cameras. The linear interpolation can include fitting a line to the poses of the real cameras. In some embodiments, the path of the virtual camera is calculated based on a curve interpolation of the poses of the real cameras. The curve interpolation can include fitting a curve to the poses of the real cameras. The curve can include an adjustable tension property. The curve interpolation can include fitting the poses of the real cameras to a TCB spline.

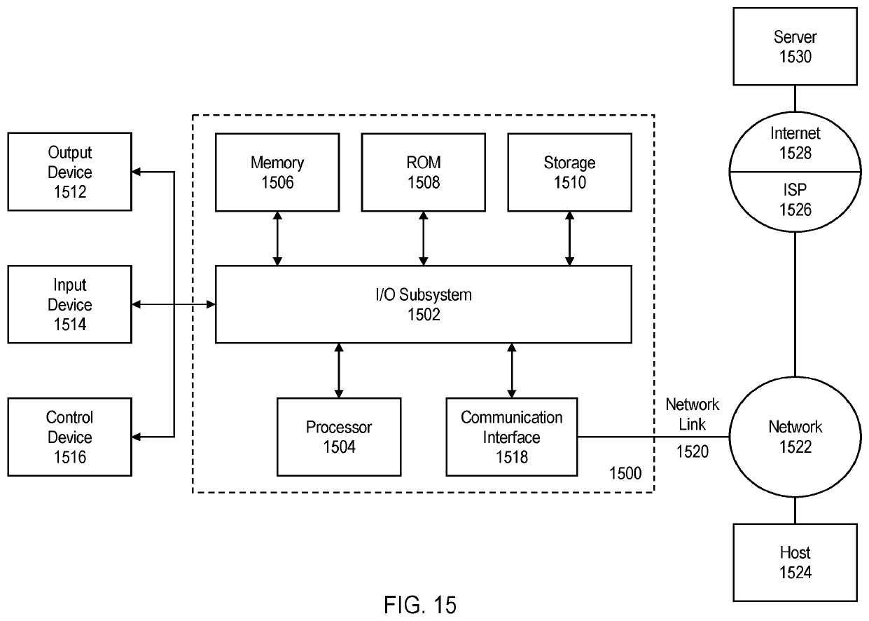

FIG. 15 illustrates a computer system 1500 configured to perform any of the steps described herein. The computer system 1500 includes an input/output (I/O) Subsystem 1502 or other communication mechanism for communicating information, and a hardware processor, or multiple processors, 1504 coupled with the I/O Subsystem 1502 for processing information. The processor(s) 1504 may be, for example, one or more general purpose microprocessors.

The computer system 1500 also includes a main memory 1506, such as a random access memory (RAM), cache and/or other dynamic storage devices, coupled to the I/O Subsystem 1502 for storing information and instructions to be executed by processor 1504. The main memory 1506 also may be used for storing temporary variables or other intermediate information during execution of instructions to be executed by the processor 1504. Such instructions, when stored in storage media accessible to the processor 1504, render the computer system 1500 into a special purpose machine that is customized to perform the operations specified in the instructions.

The computer system 1500 further includes a read only memory (ROM) 1508 or other static storage device coupled to the I/O Subsystem 1502 for storing static information and instructions for the processor 1504. A storage device 1510, such as a magnetic disk, optical disk, or USB thumb drive (Flash drive), etc., is provided and coupled to the I/O Subsystem 1502 for storing information and instructions.

The computer system 1500 may be coupled via the I/O Subsystem 1502 to an output device 1512, such as a cathode ray tube (CRT) or LCD display (or touch screen), for displaying information to a user. An input device 1514, including alphanumeric and other keys, is coupled to the I/O Subsystem 1502 for communicating information and command selections to the processor 1504. Another type of user input device is control device 1516, such as a mouse, a trackball, or cursor direction keys for communicating direction information and command selections to the processor 1504 and for controlling cursor movement on the output device 1512. This input/control device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 1500 may include a user interface module to implement a GUI that may be stored in a mass storage device as computer executable program instructions that are executed by the computing device(s). The computer system 1500 may further, as described below, implement the techniques described herein using customized hard-wired logic, one or more ASICs or FPGAs, firmware and/or program logic which in combination with the computer system causes or programs the computer system 1500 to be a special-purpose machine. According to some embodiment, the techniques herein are performed by the computer system 1500 in response to the processor(s) 1504 executing one or more sequences of one or more computer readable program instructions contained in the main memory 1506. Such instructions may be read into the main memory 1506 from another storage medium, such as storage device 1510. Execution of the sequences of instructions contained in the main memory 1506 causes the processor(s) 1504 to perform the process steps described herein. In some embodiments, hard-wired circuitry may be used in place of or in combination with software instructions.

Various forms of computer readable storage media may be involved in carrying one or more sequences of one or more computer readable program instructions to the processor 1504 for execution. For example, the instructions may initially be carried on a magnetic disk or solid state drive of a remote computer. The remote computer can load the instructions into its dynamic memory and send the instructions over a telephone line, cable, using a modem (or optical network unit with respect to fiber). A modem local to the computer system 1500 can receive the data on the telephone line and use an infra-red transmitter to convert the data to an infra-red signal. An infra-red detector can receive the data carried in the infra-red signal and appropriate circuitry can place the data on the I/O Subsystem 1502. The I/O Subsystem 1502 carries the data to the main memory 1506, from which the processor 1504 retrieves and executes the instructions. The instructions received by the main memory 1506 may optionally be stored on the storage device 1510 either before or after execution by the processor 1504.

The computer system 1500 also includes a communication interface 1518 coupled to the I/O Subsystem 1502. The communication interface 1518 provides a two-way data communication coupling to a network link 1520 that is connected to a local network 1522. For example, the communication interface 1518 may be an integrated services digital network (ISDN) card, cable modem, satellite modem, or a modem to provide a data communication connection to a corresponding type of telephone line. As another example, the communication interface 1518 may be a local area network (LAN) card to provide a data communication connection to a compatible LAN (or WAN component to communicated with a WAN). Wireless links may also be implemented. In any such implementation, the communication interface 1518 sends and receives electrical, electromagnetic or optical signals that carry digital data streams representing various types of information.

The network link 1520 typically provides data communication through one or more networks to other data devices. For example, the network link 1520 may provide a connection through the local network 1522 to a host computer 1524 or to data equipment operated by an Internet Service Provider (ISP) 1526. The ISP 1526 in turn provides data communication services through the world-wide packet data communication network now commonly referred to as the “Internet” 1528. The local network 1522 and the Internet 1528 both use electrical, electromagnetic or optical signals that carry digital data streams. The signals through the various networks and the signals on the network link X20 and through the communication interface 1518, which carry the digital data to and from the computer system 1500, are example forms of transmission media.

The computer system 1500 can send messages and receive data, including program code, through the network(s), the network link 1520 and the communication interface 1518. In the Internet example, a server 1530 might transmit a requested code for an application program through the Internet 1528, the ISP 1526, the local network 1522 and communication interface 1518.

The received code may be executed by the processor 1504 as it is received, and/or stored in the storage device 1510, or other non-volatile storage for later execution.

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In some embodiments, a processor includes an FPGA or other programmable device that performs logic operations without processing computer-executable instructions. A processor can also be implemented as a combination of computing devices, for example, a combination of a DSP and a microprocessor, one or more microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

The technology as described herein may have also been described, at least in part, in terms of one or more embodiments, none of which is deemed exclusive to the other. Various configurations may omit, substitute, or add various procedures or components as appropriate. For instance, in alternative configurations, the methods may be performed in an order different from that described, or combined with other steps, or omitted altogether. This disclosure is further non-limiting and the examples and embodiments described herein does not limit the scope of the invention.

It should be emphasized that many variations and modifications may be made to the above-described embodiments, the elements of which are to be understood as being among other acceptable examples. All such modifications and variations are intended to be included herein within the scope of this disclosure.

1.-204. (canceled)

205. A method for generating a three-dimensional (3D) representation, the method comprising:
receiving a plurality of images associated with a plurality of real cameras;
generating a point cloud based on the plurality of images, wherein the point cloud comprises a plurality of points;
selecting real cameras associated with a virtual camera, wherein the selected real cameras comprise a subset of the plurality of real cameras; and
generating a 3D representation comprising a subset of the plurality of points of the point cloud from a perspective of the virtual camera based on a relation of the virtual camera to the selected real cameras.

206. The method of claim 205, wherein the point cloud is a line cloud.

207. The method of claim 205, further comprising:
segmenting the point cloud based on a subject of interest in the plurality of images,
wherein the 3D representation comprises a subset of a plurality of points of the segmented point cloud.

208. The method of claim 205, further comprising:
segmenting each image of the plurality of images based on a subject of interest in the plurality of images,
wherein generating the point cloud is based on the plurality of segmented images.

209. The method of claim 205, further comprising:
selecting the virtual camera within a spatial constraint, wherein the spatial constraint is established based on the plurality of real cameras.

210. The method of claim 205, wherein selecting the real cameras associated with the virtual camera comprises:
comparing a pose of each real camera of the plurality of real cameras to a pose of the virtual camera; and
selecting a real camera of the plurality of real cameras responsive to a distance between a pose of the real camera and the pose of the virtual camera being less than a threshold distance value.

211. The method of claim 205, wherein selecting the real cameras associated with the virtual camera comprises selecting real cameras of the plurality of real cameras that are nearest neighbors of the virtual camera.

212. The method of claim 205, wherein selecting the real cameras associated with the virtual camera comprises:
comparing a field of view of each real camera of the plurality of real cameras to a field of view of the virtual camera; and
selecting a real camera of the plurality of real cameras responsive to the field of view of the real camera overlapping the field of view of the virtual camera.

213. The method of claim 205, wherein selecting the real cameras associated with the virtual camera comprises:
comparing capture times associated with the real cameras of the plurality of real cameras to one another; and
selecting real cameras of the plurality of real cameras responsive to the real cameras being temporally proximate to one another.

214. The method of claim 205, wherein generating the 3D representation comprising the subset of the plurality of points of the point cloud from the perspective of the virtual camera comprises:
selecting points of the plurality of points of the point cloud that were observed by the selected real cameras associated with the virtual camera,
wherein the subset of the plurality of points of the point cloud comprises the selected points.

215. The method of claim 205, further comprising:
generating a two-dimensional (2D) representation of the 3D representation from the perspective of the virtual camera.

216. The method of claim 205, wherein generating the 3D representation comprising the subset of the plurality of points of the point cloud from the perspective of the virtual camera comprises generating a color value for each point of the subset of the plurality of points.

217. The method of claim 216, wherein generating the color value for each point of the subset of the plurality of points comprises selecting a predominant color value of pixel color values according to the images that were used to triangulate the point.

218. One or more non-transitory computer-readable media storing one or more sequences of instructions that, when executed by one or more processors, cause:
receiving a plurality of images associated with a plurality of real cameras;
generating a point cloud based on the plurality of images, wherein the point cloud comprises a plurality of points;
selecting real cameras associated with a virtual camera, wherein the selected real cameras comprise a subset of the plurality of real cameras; and
generating a 3D representation comprising a subset of the plurality of points of the point cloud from a perspective of the virtual camera based on a relation of the virtual camera to the selected real cameras.

219. A method for generating a three-dimensional (3D) representation, the method comprising:
receiving a plurality of images associated with a plurality of real cameras;
generating a point cloud based on the plurality of images, wherein the point cloud comprises a plurality of points;
selecting points of the point cloud associated with a virtual camera, wherein the selected points comprise a subset of the plurality of points; and
generating a 3D representation comprising the selected points from a perspective of the virtual camera based on a relation of the virtual camera to the selected points.

220. A method for generating a three-dimensional (3D) representation, the method comprising:
receiving a plurality of images associated with a plurality of real cameras;
generating a point cloud based on the plurality of images, wherein the point cloud comprises a plurality of points;
calculating distances between the plurality of real cameras and a virtual camera; and
generating a three-dimensional (3D) representation comprising a subset of the plurality of points of the point cloud from a perspective of the virtual camera based on the distances between the plurality of real cameras and the virtual camera.

221. A method for rendering points, the method comprising:
receiving a plurality of images associated with a plurality of real cameras;
generating a point cloud based on the plurality of images, wherein the point cloud comprises a plurality of points;
selecting first real cameras associated with a first virtual camera, wherein the first real cameras comprise a first subset of the plurality of real cameras;
selecting second real cameras associated with a second virtual camera, wherein the second real cameras comprise a second subset of the plurality of real cameras;
selecting a first plurality of points of the point cloud based on a first relation of the first virtual camera to the first real cameras;
selecting a second plurality of points of the point cloud based on a second relation of the second virtual camera to the second real cameras; and
rendering the first plurality of points and the second plurality of points based on a transition from the first virtual camera to the second virtual camera.

222. A method for generating a path of a virtual camera, the method comprising:
receiving a plurality of images;
for each image of the plurality of images, calculating a pose of a real camera associated with the image; and
generating a path of a virtual camera based on the calculated poses of the real cameras.
